(19) United States
(12) Patent Application Publication
(10) Pub. No.: US 2025/0298204 A1
(43) Pub. Date: Sep. 25, 2025

(54) OPTICAL MODULE

(71) Applicant: HISENSE BROADBAND MULTIMEDIA TECHNOLOGIES CO., LTD., Qingdao (CN)

(72) Inventors: Qiang ZHANG, Qingdao (CN); Qisheng ZHAO, Qingdao (CN); Shihai YANG, Qingdao (CN); Huaqing DAI, Qingdao (CN); Gen DU, Qingdao (CN); Wei WANG, Qingdao (CN); Yang LIU, Qingdao (CN); Chunqiu ZHANG, Qingdao (CN); Jiahui ZHAO, Qingdao (CN)

(21) Appl. No.: 19/231,164

(22) Filed: Jun. 6, 2025

Related U.S. Application Data
(63) Continuation of application No. PCT/CN2023/136112, filed on Dec. 4, 2023.

(30) Foreign Application Priority Data
Dec. 6, 2022 (CN) 202211555988.9
Jun. 12, 2023 (CN) 202310695911.X
Jul. 13, 2023 (CN) 202310861903.8

(51) Int. Cl. G02B 6/42; G02F 1/01; G02F 1/035; G02F 1/21

(52) U.S. Cl. CPC G02B 6/4286; G02F 1/0121; G02F 1/035; G02F 1/212; G02F 2201/58; G02F 2202/20

(57) ABSTRACT

An optical module includes: an optical modulation chip having an optical modulator, the optical modulator including a phase converter, a first optical power detection assembly and a second optical power detection assembly arranged at light input and light output sides of the optical modulator, a comparison circuit configured to receive a second detection voltage and a first detection voltage from the second and first optical power detection assemblies and output a comparison voltage; and an MCU configured to monitor the comparison voltage and output a bias voltage to the phase converter, adjust the bias voltage to the phase converter in case of monitoring the comparison voltage not equal to a preset voltage while the optical module is in a preset state, such that a difference between the first detection voltage and the second detection voltage is a preset difference, thereby adjusting the comparison voltage to a preset voltage.

The present disclosure is a Continuation Application of international patent application No. PCT/CN2023/136112, filed on Dec. 4, 2023, which claims priority to Chinese Patent Application No. 202211555988.9, filed on Dec. 6, 2022, Chinese Patent Application No. 202310695911.X, filed on Jun. 12, 2023, and Chinese Patent Application No. 202310861903.8, filed on Jul. 13, 2023, the entire content of which is incorporated herein by reference.

### FIELD OF THE INVENTION

The present disclosure relates to the field of optical fiber communication technology, in particular to an optical module.

### BACKGROUND OF THE INVENTION

With the development of new services and application models such as cloud computing, mobile Internet, and video, the progress of optical communication technology has become more and more important. In optical communication technology, optical modules, as one of the key devices in optical communication equipment, can achieve the conversion between optical signals and electrical signals. In the development of optical communication technology, the data transmission rate of optical modules is required to continuously increase.

### SUMMARY OF THE INVENTION

The present disclosure provides an optical module, including:
a light source configured to emit direct current light that does not carry data;
an optical modulation chip which includes an optical modulator, the optical modulator being configured to modulate the direct current light that does not carry data into an optical signal, and the optical modulator including a phase converter;
a first optical power detection assembly arranged at a light input side of the optical modulator, a detection voltage of the first optical power detection assembly being a first detection voltage;
a second optical power detection assembly arranged at a light output side of the optical modulator, a detection voltage of the second optical power detection assembly being a second detection voltage, where the optical module is in a preset state when a difference between the first detection voltage and the second detection voltage is a preset difference;
a comparison circuit, where a first input of the comparison circuit receives the second detection voltage, a second input of the comparison circuit receives the first detection voltage, the comparison circuit is configured to output a comparison voltage according to the first detection voltage and the second detection voltage, and the optical module is in the preset state when the comparison voltage is a preset voltage; and
an MCU which is configured to adjust a bias voltage that is provided to the phase converter in case of monitoring that the comparison voltage is not equal to the preset voltage while the optical module is in the preset state, such that the difference between the first detection voltage and the second detection voltage is the preset difference, thereby adjusting the comparison voltage to the preset voltage.

### BRIEF DESCRIPTION OF THE DRAWINGS

In order to more clearly illustrate the technical solutions of the embodiments of the present disclosure, the drawings required to be used in the descriptions of the embodiments or prior art will be briefly introduced below. It is obvious that the drawings described below are only some embodiments of the present disclosure. Those of ordinary skill in the art can obtain other drawings according to these drawings without creative efforts.

FIG. 1 is a partial structural diagram of an optical communication system provided according to some embodiments of the present disclosure;

FIG. 2 is a local structure diagram of a host computer provided according to some embodiments of the present disclosure;

FIG. 3 is a structural diagram of an optical module provided according to some embodiments of the present disclosure;

FIG. 4 is an exploded view of an optical module provided according to some embodiments of the present disclosure;

FIG. 5 is an internal structure diagram of an optical module provided according to some embodiments of the present disclosure;

FIG. 6 is a structure diagram of an optical module without a shell and an unlocking part provided according to some embodiments of the present disclosure;

FIG. 7 is a structure diagram of an optical fiber adapter, a local oscillator optical assembly, a coherent optical assembly, and a circuit board in an optical module provided according to some embodiments of the present disclosure;

FIG. 8 is a first structural diagram of an electro-optical modulator in an optical module provided according to some embodiments of the present disclosure;

FIG. 9 is a signal diagram of an electro-optical modulator in an optical module provided according to some embodiments of the present disclosure;

FIG. 10 is a structure block diagram of an optical module provided according to some embodiments of the present disclosure;

FIG. 11 is a second structural diagram of an electro-optical modulator in an optical module provided according to some embodiments of the present disclosure;

FIG. 12 is a structural diagram of a first optical power detection assembly in an optical module provided according to some embodiments of the present disclosure;

FIG. 13 is a third structural diagram of an electro-optical modulator in an optical module provided according to some embodiments of the present disclosure;

FIG. 14 is an internal structure diagram of another optical module provided according to some embodiments of the present disclosure;

FIG. 15 is a structural diagram of an optical modulation chip in another optical module provided according to some embodiments of the present disclosure;

FIG. 16 is a structural diagram of a first optical power detection assembly in another optical module provided according to some embodiments of the present disclosure;

FIG. 17 is a structural diagram of a second optical power detection assembly in another optical module provided according to some embodiments of the present disclosure;

FIG. 18 is a structural diagram of a comparison circuit in another optical module provided according to some embodiments of the present disclosure;

FIG. 19 is a schematic diagram of the interaction between an MCU and a phase converter in another optical module provided according to some embodiments of the present disclosure;

FIG. 20 is a first block diagram of a structure on a circuit board in another optical module provided according to some embodiments of the present disclosure;

FIG. 21 is a second block diagram of a structure on a circuit board in another optical module provided according to some embodiments of the present disclosure;

FIG. 22 is a third block diagram of a structure on a circuit board in another optical module provided according to some embodiments of the present disclosure; and

FIG. 23 is a fourth block diagram of a structure on a circuit board in another optical module provided according to some embodiments of the present disclosure.

### DETAILED DESCRIPTION OF THE EMBODIMENTS

The technical solutions in some embodiments of the present disclosure will be clearly and completely described below with reference to the accompanying drawings, and it is obvious that the embodiments described are only some embodiments of the present disclosure, not all embodiments. According to the embodiments provided in the present disclosure, all other embodiments obtained by a person of ordinary skill in the art fall within the scope of protection of the present disclosure.

Unless the context otherwise requires, throughout the specification and claims, the term “comprise” and its other forms, such as a third person singular form “comprises” and a present participle form “comprising”, are construed to mean open, inclusive, i.e., “including, but not limited to”. In the description of the specification, the terms “one embodiment”, “some embodiments”, “exemplary embodiments”, “example”, “specific example”, or “some examples” etc., are intended to indicate that specific features, structures, materials, or characteristics related to the embodiment or example are included in at least one embodiment or example of the present disclosure. The schematic representation of the above terms does not necessarily refer to the same embodiment or example. In addition, the described particular features, structures, materials, or characteristics may be included in any one or more embodiments or examples in any appropriate manner.

Hereinafter, the terms “first” and “second” are used for descriptive purposes only and should not be construed as indicating or implying relative importance or implying the number of technical features indicated. Thus, the features that are defined as “first” and “second” may explicitly or implicitly include one or more of these features. In the description of the embodiments of the present disclosure, unless otherwise specified, “a plurality of” means two or more.

In describing some embodiments, the expressions “coupling” and “connection” and their extensions may be used. For example, the term “connection” may be used to describe some embodiments to indicate that two or more parts are in direct physical or electrical contact with each other. As another example, the term “coupling” may be used to describe some embodiments to indicate that two or more parts are in direct physical or electrical contact. However, the term “coupling” or “communicatively coupled” may also refer to two or more parts that are not in direct contact with each other, but still cooperate or interact with each other. The embodiments disclosed here are not necessarily limited to the content of this document.

“At least one of A, B and C” has the same meaning as “at least one of A, B or C” and includes the following combinations of A, B and C: A only, B only, C only, a combination of A and B, a combination of A and C, a combination of B and C, and a combination of A, B and C.

“A and/or B” includes the following three combinations: A only, B only, and a combination of A and B.

The use of “applicable to” or “configured to” in this document implies open and inclusive language that does not exclude devices that are applicable to or configured to perform additional tasks or steps.

As used herein, “about”, “roughly” or “approximately” includes the value described and the average value within an acceptable deviation range of a particular value, as determined by a person of ordinary skill in the art taking into account the measurement in question and the errors associated with the measurement of a particular quantity (i.e., the limitations of a measurement system).

In optical communication technology, in order to establish information transmission between information processing devices, it is necessary to load information onto light and use the propagation of light to achieve the transmission of information. Here, the light loaded with information is an optical signal. When the optical signal is transmitted in an information transmission device, the loss of optical power can be reduced, so high-speed, long-distance, and low-cost information transmission can be achieved. The signals that the information processing devices are able to recognize and process are electrical signals. The information processing devices usually include optical network units (ONU), gateways, routers, switches, mobile phones, computers, servers, tablet computers, televisions, etc., and the information transmission devices usually include optical fibers and optical waveguides, etc.

The optical modules can achieve the conversion between optical signals and electrical signals from the information processing devices and the information transmission devices. For example, at least one of an optical signal input or an optical signal output of an optical module is connected to an optical fiber, and at least one of an electrical signal input or an electrical signal output of the optical module is connected to an optical network unit; a first optical signal from the optical fiber is transmitted to the optical module, and the optical module converts the first optical signal into a first electrical signal and transmits the first electrical signal to the optical network unit; and a second electrical signal from the optical network unit is transmitted to the optical module, and the optical module converts the second electrical signal into a second optical signal and transmits the second optical signal to the optical fiber. Since information can be transmitted through electrical signals between a plurality of information processing devices, at least one information processing device in the plurality of information processing devices is required to be directly connected to the optical module, and all information processing devices are not required to be directly connected to the optical module. Here, the information processing device directly connected to the optical module is called a host computer of the optical module. In addition, the optical signal input or the optical signal output of the optical module can be called an optical port, and the electrical signal input or the electrical signal output of the optical module can be called an electrical port.

FIG. 1 is a partial structural diagram of an optical communication system according to some embodiments. As shown in FIG. 1, the optical communication system mainly includes a remote information processing device 1000, a local information processing device 2000, a host computer 100, an optical module 200, an optical fiber 101, and a network cable 103.

One end of the optical fiber 101 extends in the direction of the remote information processing device 1000, and the other end of the optical fiber 101 is connected to the optical module 200 through the optical port of the optical module 200. The optical signal can be fully reflected in the optical fiber 101, and the propagation of the optical signal in the direction of total reflection can almost maintain the original optical power. The optical signal undergoes multiple total reflections in the optical fiber 101 to transmit the optical signal from the remote information processing device 1000 to the optical module 200, or to transmit the optical signal from the optical module 200 to the remote information processing device 1000, so as to achieve long-distance and low-power-loss information transmission.

The optical communication system may include one or more optical fibers 101, and the optical fibers 101 are detachably or fixedly connected to the optical module 200. The host computer 100 is configured to provide a data signal to the optical module 200, or receive the data signal from the optical module 200, or monitor or control a working state of the optical module 200.

The host computer 100 includes a housing that is roughly a cuboid and an optical module interface 102 arranged on the housing. The optical module interface 102 is configured to be connected to the optical module 200 such that the host computer 100 establishes a one-way or two-way electrical signal connection with the optical module 200.

The host computer 100 further includes an external electrical interface, and this external electrical interface can be connected to an electrical signal network. For example, this external electrical interface includes a universal serial bus (USB) interface or a network cable interface 104, and the network cable interface 104 is configured to be connected to the network cable 103 such that the host computer 100 establishes a one-way or two-way electrical signal connection with the network cable 103. One end of the network cable 103 is connected to the local information processing device 2000, and the other end of the network cable 103 is connected to the host computer 100, such that an electrical signal connection is established between the local information processing device 2000 and the host computer 100 through the network cable 103. For example, a third electrical signal sent by the local information processing equipment 2000 is transmitted to the host computer 100 through the network cable 103, the host computer 100 generates a second electrical signal according to the third electrical signal, the second electrical signal from the host computer 100 is transmitted to the optical module 200, the optical module 200 converts the second electrical signal into a second optical signal and transmits the second optical signal to the optical fiber 101, and the second optical signal is transmitted to the remote server 1000 through the optical fiber 101. For example, a first optical signal from the remote information processing device 1000 propagates through the optical fiber 101, the first optical signal from the optical fiber 101 is transmitted to the optical module 200, the optical module 200 converts the first optical signal into a first electrical signal, the optical module 200 transmits the first electrical signal to the host computer 100, and the host computer 100 generates a fourth electrical signal according to the first electrical signal and transmits the fourth electrical signal to the local information processing equipment 2000. It should be noted that the optical module is a tool to achieve the conversion between optical signals and electrical signals, and in the conversion between the optical signals and the electrical signals, the information remains unchanged, and the encoding and decoding methods of the information may vary.

In addition to the optical network unit, the host computer 100 further includes an optical line terminal (OLT), an optical network terminal (ONT), or a data center server, etc.

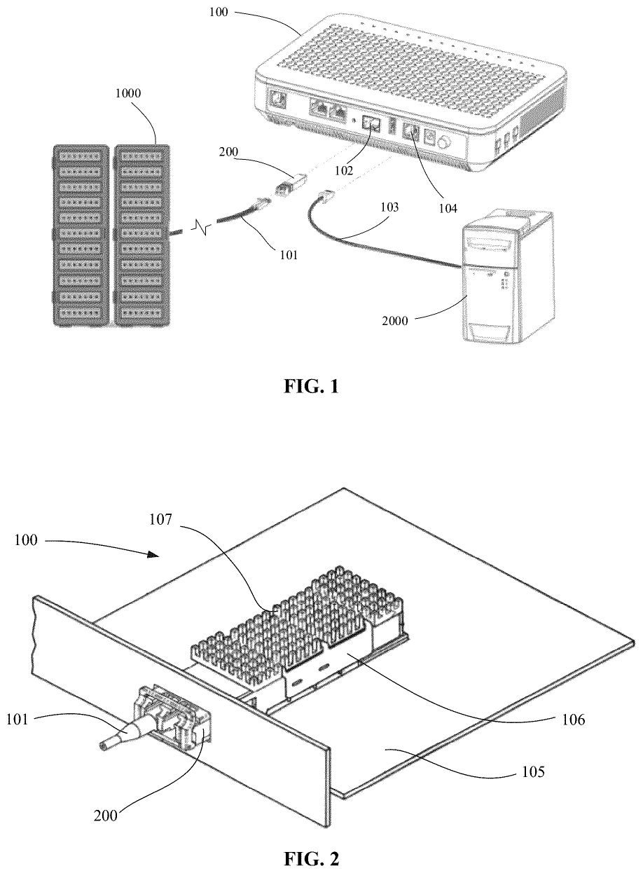

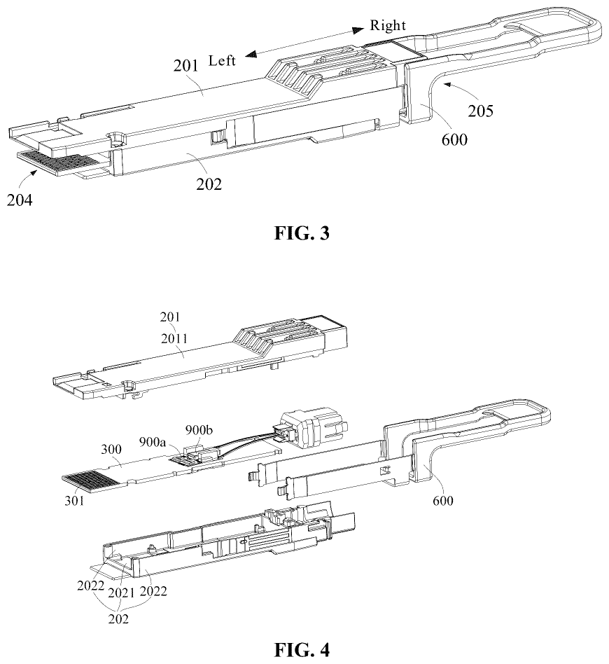

FIG. 2 is a local structure diagram of a host computer according to some embodiments. In order to clearly show the connection relationship between the optical module 200 and the host computer 100, FIG. 2 shows only the structure of the host computer 100 related to the optical module 200. As shown in FIG. 2, the host computer 100 further includes a printed circuit board (PCB) 105 arranged in the housing, a cage 106 arranged on the surface of the PCB 105, a heat sink 107 arranged on the cage 106, and an electrical connector arranged inside the cage 106. The electrical connector is configured to be connected to the electrical port of the optical module 200. The heat sink 107 has protruding structures such as fins that enlarge the heat dissipation area.

The optical module 200 is inserted into the cage 106 of the host computer 100, and the optical module 200 is fixed by the cage 106. Heat generated by the optical module 200 is conducted to the cage 106 and then diffused through the heat sink 107. After the optical module 200 is inserted into the cage 106, the electrical port of the optical module 200 is connected to the electrical connector inside the cage 106, such that the optical module 200 and the host computer 100 establish a two-way electrical signal connection. In addition, the optical port of the optical module 200 is connected to the optical fiber 101, such that the optical module 200 and the optical fiber 101 establish a two-way optical signal connection.

FIG. 3 is a structural diagram of an optical module provided according to some embodiments of the present disclosure, and FIG. 4 is an exploded view of an optical module provided according to some embodiments of the present disclosure. As shown in FIG. 3 and FIG. 4, the optical module 200 includes a shell, a circuit board 300 arranged in the shell, an optical modulation chip 900a, a light source 900b, etc., but the present disclosure is not limited to this.

The shell includes an upper shell 201 and a lower shell 202, where the upper shell 201 covers the lower shell 202 to form the shell with an opening 204 and an opening 205; and the outer contour of the shell is generally square.

In some embodiments, the lower shell 202 includes a base plate 2021 and two lower side plates 2022 located on two sides of the base plate 2021 and perpendicular to the base plate 2021; and the upper shell 201 includes a cover plate 2011, where the cover plate 2011 covers the two lower side plates 2022 of the lower shell 202 to form the shell.

In some embodiments, the lower shell 202 includes a base plate 2021 and two lower side plates 2022 located on two sides of the base plate 2021 and perpendicular to the base plate 2021; and the upper shell 201 includes a cover plate 2011 and two upper side plates located on two sides of the cover plate 2011 and perpendicular to the cover plate 2011, where the two upper side plates and the two lower side plates 2022 are combined to ensure that the upper shell 201 covers the lower shell 202.

The direction of a connecting line between the opening 204 and the opening 205 may be consistent with the length direction of the optical module 200 or may be inconsistent with the length direction of the optical module 200. For example, the opening 204 is located at the end part of the optical module 200 (the left end of FIG. 3), and the opening 205 is also located at the end part of the optical module 200 (the right end of FIG. 3). Alternatively, the opening 204 is located at the end part of the optical module 200, and the opening 205 is located at the side part of the optical module 200. The opening 204 is an electrical port, and a gold finger 301 of the circuit board 300 extends out from the electrical port and is inserted into the electrical connector of the host computer 100; and the opening 205 is an optical port, which is configured to be connected to the external optical fiber 101 such that the optical fiber 101 is connected to the optical modulation chip 900a and the light source 900b in the optical module 200.

The assembly method of combining the upper shell 201 with the lower shell 202 is adopted, such that the circuit board 300, the optical modulation chip 900a, the light source 900b, etc. can be conveniently mounted in the above-mentioned shell, and the above-mentioned devices can be encapsulated and protected by the upper shell 201 and the lower shell 202. In addition, when the circuit board 300, the optical modulation chip 900a, the light source 900b, etc. are assembled, the assembly method of combining the upper shell 201 with the lower shell 202 is convenient for the deployment of positioning parts, heat dissipation parts, and electromagnetic shielding parts of these devices, and is conducive to the automatic production.

In some embodiments, the upper shell 201 and the lower shell 202 are made of metal materials, which is conducive to electromagnetic shielding and heat dissipation.

In some embodiments, the optical module 200 further includes an unlocking part 600 located outside the shell. The unlocking part 600 is configured to achieve a fixed connection between the optical module 200 and the host computer, or to release the fixed connection between the optical module 200 and the host computer.

For example, the unlocking part 600 is located at the outer side of the two lower side plates 2022 of the lower shell 202 and includes a clamping part matching the cage 106 of the host computer 100. When the optical module 200 is inserted into the cage 106, the optical module 200 is fixed in the cage 106 by the clamping part of the unlocking part 600; and when the unlocking part 600 is pulled, the clamping part of the unlocking part 600 moves accordingly, such that the connection relationship between the clamping part and the host computer is changed to release the fixation between the optical module 200 and the host computer, thereby pulling out the optical module 200 from the cage 106.

The circuit board 300 includes circuit traces, electronic components, and chips, etc., where the electronic components and the chips are connected according to the circuit design through the circuit traces to implement the functions such as power supply, electrical signal transmission, and grounding. The electronic components may include, for example, capacitors, resistors, transistors, and metal-oxide-semiconductor field-effect transistors (MOSFETs). The chips may include, for example, microcontroller units (MCUs), laser driving chips, transimpedance amplifiers (TIAs), limiting amplifiers, clock and data recovery (CDR) chips, power management chips, and digital signal processing (DSP) chips.

The circuit board 300 is generally a rigid circuit board. The rigid circuit board can also achieve the bearing effect because of its relatively hard material, for example, the rigid circuit board can smoothly carry the above-mentioned electronic components and chips. The rigid circuit board can also be inserted into the electrical connector in the cage 106 of the host computer 100.

The board 300 further includes a gold finger 301 formed on the end surface thereof, where the gold finger 301 consists of a plurality of pins that are independent of each other. The circuit board 300 is inserted into the cage 106, and the gold finger 301 is connected to the electrical connector in the cage 106. The gold finger 301 may be arranged only on the surface of one side of the circuit board 300 (such as the upper surface shown in FIG. 4), or may be arranged on the surfaces of the upper and lower sides of the circuit board 300 to provide more pins, so as to adapt to the occasion where a large number of pins are required. The gold finger 301 is configured to establish an electrical connection with the host computer to achieve power supply, grounding, two-wire inter-integrated circuit (I2C) signal transmission, data signal transmission, etc. Certainly, flexible circuit boards are also used in some optical modules. Flexible circuit boards are generally used in conjunction with rigid circuit boards as a supplement to rigid circuit boards.

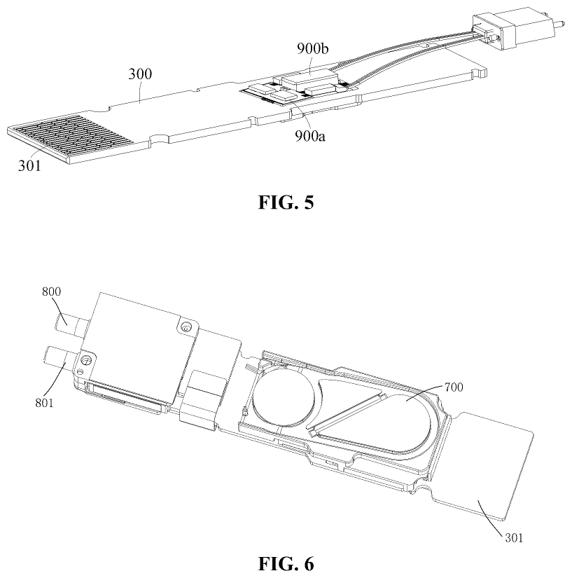

FIG. 5 is an internal structure diagram of an optical module provided according to some embodiments of the present disclosure. As shown in FIG. 5, the optical modulation chip 900a itself has no light source, so the light source 900b is selected as the external light source of the optical modulation chip 900a. A laser box may be selected as the light source 900b, where a laser chip is encapsulated inside the laser box, and the laser chip emits light to produce a laser beam. The light source 900b is configured to provide emitted laser light to the optical modulation chip 900a. The laser light becomes the preferred light source for the optical module and even optical fiber transmission due to its excellent single-wavelength characteristics and superior wavelength-tuning characteristics, and other types of light such as LED light are generally not adopted in common optical communication systems. Even if this light source is used in a special optical communication system, the characteristics of the light source and the chip part are quite different from the laser light, such that there is a large technical difference between the optical module using the laser light and the optical module using other light sources. Those skilled in the art generally do not think that these two types of optical modules can give each other technical enlightenment.

The bottom surface of the optical modulation chip 900a and the bottom surface of the light source 900b are arranged on the substrate. An optical connection is established between the optical modulation chip 900a and the light source 900b. An optical path is very sensitive to the position relationship between the optical modulation chip and the light source. Materials with different expansion coefficients lead to the formation of different degrees, which is not conducive to the realization of the preset optical path.

In the embodiments of the present disclosure, the optical modulation chip 900a and the light source 900b are arranged on the same substrate, and when the substrate made of the same material is deformed, the positions of the optical modulation chip 900a and the light source 900b will be equally affected, and the relative positions of the optical modulation chip 900a and the light source 900b will be prevented from being greatly changed. In some embodiments, it is preferable that the expansion coefficient of the substrate material is close to the expansion coefficient of the material of the optical modulation chip 900a and/or the light source 900b.

In some embodiments, the optical modulation chip 900a may be a silicon photonic chip, or a thin-film lithium niobate chip, etc., for example, the optical modulation chip 900a is the thin-film lithium niobate chip. The thin-film lithium niobate chip includes a substrate and an optical modulation thin film layer located on the surface of the substrate, where the optical modulation thin film layer has an input optical waveguide, a Mach Zehnder modulator (MZM), and an output optical waveguide inside, the substrate is a glass substrate, the optical modulation thin film layer may be a lithium niobate thin film, which is laid on the substrate, and the thickness of the lithium niobate thin film is less than 100 μm.

The thin-film lithium niobate chip has relatively small size and relatively high integration precision. Compared with the silicon photonic chip, the thin-film lithium niobate chip has the advantages of low power consumption, low optical loss, and the like. The optical loss of the silicon photonic chip is less than 11.2 dB, and the optical loss of the thin-film lithium niobate chip is less than 10 dB.

Light provided by the light source 900b to the optical modulation chip 900a, such as a thin-film lithium niobate chip, is an emission light with a single wavelength and stable power, which does not carry any signal, and the emission light is modulated by the thin-film lithium niobate chip to load data into the emission light to obtain a modulated optical signal.

In some embodiments, the side surface of the optical modulation chip 900a, such as a thin-film lithium niobate chip, receives the emission light from the light source 900b, the modulation of the emission light is completed by the thin-film lithium niobate chip, and the surface of the thin-film lithium niobate chip is provided with a pad that is electrically connected to the circuit board 300 by means of wire bonding. In this way, the circuit board 300 provides a data signal from the host computer to the thin-film lithium niobate chip, the data signal is modulated into the emission light by the thin-film lithium niobate chip to obtain a modulated optical signal, and the modulated optical signal is transmitted to the host computer.

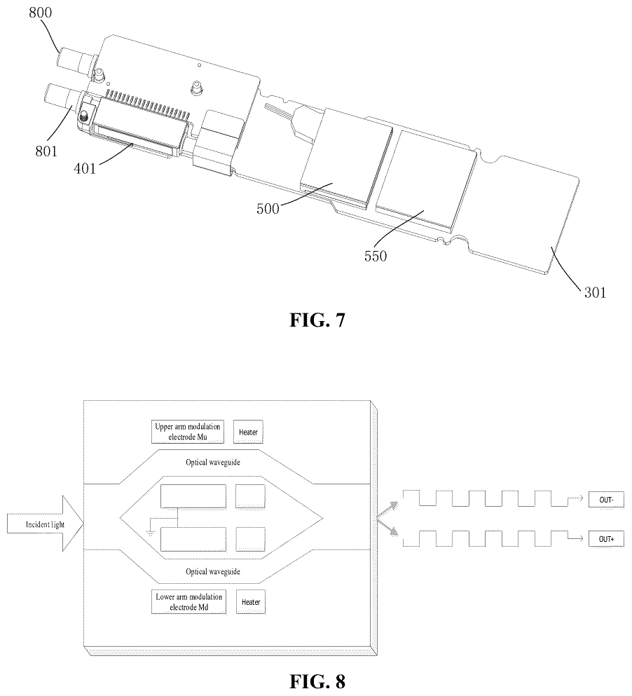

FIG. 6 is a structure diagram of an optical module without a shell and an unlocking part provided according to some embodiments of the present disclosure; and FIG. 7 is a structure diagram of an optical fiber adapter, a local oscillator optical assembly, a coherent optical assembly, and a circuit board in an optical module provided according to some embodiments of the present disclosure.

As shown in FIG. 6 and FIG. 7, the light source (which, in this example, may be referred to as a local oscillator optical assembly 401) is connected to the circuit board 300 and configured to emit a light beam with a preset specific wavelength. Specifically, the local oscillating optical assembly 401 includes a semiconductor gain chip and a silicon photonic chip, where the semiconductor gain chip emits light beams within a wavelength band range, the silicon photonic chip screens out a light beam with a specific wavelength from the light beams within the wavelength band range, and the light beam with the specific wavelength is reflected back and forth between the silicon photonic chip and the semiconductor gain chip, such that the silicon photonic chip and the semiconductor gain chip form a resonant cavity to achieve the stable output of the light beam with the specific wavelength.

The optical module further includes an emission optical fiber adapter 800 and a reception optical fiber adapter 801. The emission optical fiber adapter 800 is configured to transmit a high-speed optical signal, and the reception optical fiber adapter 801 is configured to receive the high-speed optical signal.

The optical modulation chip (which, in this example, may be referred to as a coherent optical assembly 500) is placed on the circuit board and configured to achieve the conversion between high-speed optical and electrical signals. Specifically, the coherent optical assembly 500 includes an optical emission interface, an optical reception interface, and a local oscillator optical interface. In some examples, the optical emission interface extends out of a first optical fiber, the optical reception interface extends out of a second optical fiber, the local oscillator optical interface extends out of a third optical fiber, the optical emission interface is connected to the emission optical fiber adapter 800, the optical reception interface is connected to the reception optical fiber adapter 801, and the local oscillator optical interface is connected to the local oscillator optical assembly 401. The coherent optical assembly is connected to the emission optical fiber adapter, the reception optical fiber adapter, and the local oscillator optical assembly 401 respectively through the optical emission interface, the optical reception interface, and the local oscillator optical interface, and the coherent optical assembly 500 is further connected to a DSP chip 550.

Narrow-linewidth and high-power laser light emitted by the local oscillator optical assembly 401 is input to the coherent optical assembly 500 through the local oscillator optical interface, and the laser light is split into beams inside the coherent optical assembly 500, where a beam is used as an emitted beam and enters a coherent modulator inside the coherent optical assembly, electrical and optical signal conversion is performed under the driving of the high-speed electrical signal of the DSP chip 550, and the converted high-speed optical signal is output from the optical emission interface of the module; and another beam is used as a local oscillator beam, the high-speed optical signal input to the coherent optical assembly 500 from the optical reception interface of the module is coherently demodulated, and the demodulated electrical signal enters the DSP chip 550 for signal processing, so as to complete the optical and electrical signal conversion. The narrow-linewidth and high-power laser light is a light beam with a specific wavelength.

In some examples, the local oscillator optical assembly 401 further includes an internal optical fiber adapter, where the internal optical fiber adapter extends out of the first optical fiber, the local oscillator optical interface extends out of a local oscillator optical fiber, and the first optical fiber is fusion-spliced to the local oscillator optical fiber, such that the internal optical fiber adapter is connected to the local oscillator optical interface. The emission optical fiber adapter 800 extends out of the second optical fiber, the optical emission interface extends out of an emission optical fiber, and the second optical fiber is fusion-spliced to the emission optical fiber, such that the emission optical fiber adapter 800 is connected to the optical emission interface. The reception optical fiber adapter 801 extends out of the third optical fiber, the optical reception interface extends out of a reception optical fiber, and the third optical fiber is fusion-spliced to the reception optical fiber, such that the reception optical fiber adapter 801 is connected to the optical reception interface.

Since there is a certain failure rate during the fusion splicing of two optical fibers, in order to ensure the successful final fusion splicing of the two optical fibers, a certain length of the optical fiber needs to be reserved, such that the two optical fibers can continue to be fusion-spliced after the fusion splicing failure. Because a connection point of fusion splicing between the first optical fiber and the local oscillator optical fiber is located near the internal optical fiber adapter, a connection point of fusion splicing between the second optical fiber and the emission optical fiber is located near the emission optical fiber adapter 800, and a connection point of fusion splicing between the third optical fiber and the reception optical fiber is located near the reception optical fiber adapter 801, the first optical fiber, the local oscillator optical fiber, the emission optical fiber, and the reception optical fiber are relatively long.

An optical fiber winding frame 700 is configured to fix the optical fibers. Specifically, because the circuit board 300 is provided with high-frequency signal lines and many devices, the optical fibers cannot be directly laid on the surface of the circuit board 300. Because the first optical fiber, the local oscillator optical fiber, the emission optical fiber, and the reception optical fiber are relatively long, in order to prevent the upper shell from crushing the first optical fiber, the local oscillator optical fiber, the emission optical fiber, and the reception optical fiber, the optical fiber winding frame 700 for fixing the optical fibers is arranged between the coherent optical assembly 500 and the upper shell 201.

The first optical fiber, the local oscillator optical fiber, the emission optical fiber, and the reception optical fiber are all neatly fixed on the optical fiber winding frame 700, which not only prevents the upper shell from crushing the first optical fiber, the local oscillator optical fiber, the emission optical fiber, and the reception optical fiber, but also avoids the signal crosstalk problem caused by the optical fibers directly laid on the surface of the circuit board 300.

FIG. 8 is a first structural diagram of an electro-optical modulator in an optical module provided according to some embodiments of the present disclosure, and FIG. 9 is a signal diagram of an electro-optical modulator in an optical module provided according to some embodiments of the present disclosure. As shown in FIG. 8 and FIG. 9, the optical modulation chip 900a, such as a thin-film lithium niobate chip, includes an optical modulator, where the optical modulator may be a Mach Zehnder modulator (MZM). When incident light is emitted into the MZM modulator, the incident light is split into two beams of light with identical amplitude and frequency at a first Y-branch after traveling a certain distance, and the two beams of light pass through two branches of the optical waveguide respectively, and converge and interfere at a second Y-branch for output. It can also be understood that the MZM modulator splits the input light into two beams of light, which then enter optical branches of the modulator respectively. The materials used in these two optical branches are electro-optic materials, and their phase varies with the magnitude of an externally applied electrical signal. Since the phase change of the optical branch will lead to the change of the optical phase, when outputs of two branch signal modulators are recombined, the combined optical signal is an interference signal with a change in intensity. This is equivalent to converting the change of the electrical signal into the change of the optical signal, thereby achieving the modulation of light.

In the MZM modulator, the lithium niobate optical waveguide undergoes an electro-optical effect under the action of an electrode voltage to form electro-optical modulation. Because two electrodes (an upper arm modulation electrode Mu and a lower arm modulation electrode Md) are of a symmetrical structure, voltages at two arms of the MZM modulator are equal in magnitude and opposite in direction, such that phase shifts of two branch optical waves are equal in magnitude and opposite in direction.

When the phase difference generated by electro-optical modulation is 0 or π, an optical carrier signal undergoes constructive interference or destructive interference, so as to complete the modulation of the optical carrier signal. When the phase difference generated by electro-optical modulation is π/2, the relative output light intensity of the electro-optical modulator is linearly related to the electrode voltage, and the dynamic range and conversion efficiency of an output signal are both the maximum, so it is necessary to add an appropriate direct current component to the electrode voltage to ensure the establishment of an appropriate working point. When the direct current component forms a phase difference of π/2 for the two optical waves, the linearity is the highest, and linear modulation can be achieved, that is, an external direct current bias voltage is required to keep the working point stable in the state where the phase difference is π/2.

Under ideal circumstances, the MZM modulator can work stably at this working point. However, with the influence of a series of external conditions such as time, ambient temperature, optical power of a laser, and insertion and coupling loss of optical fibers, the optimal working point of the MZM modulator will drift, resulting in poor signal quality, increased bit error rate and other undesirable effects. In order to ensure that the optimal working point is in the stable state for a long time, it is needed to increase compensation for the drift of the optimal working point.

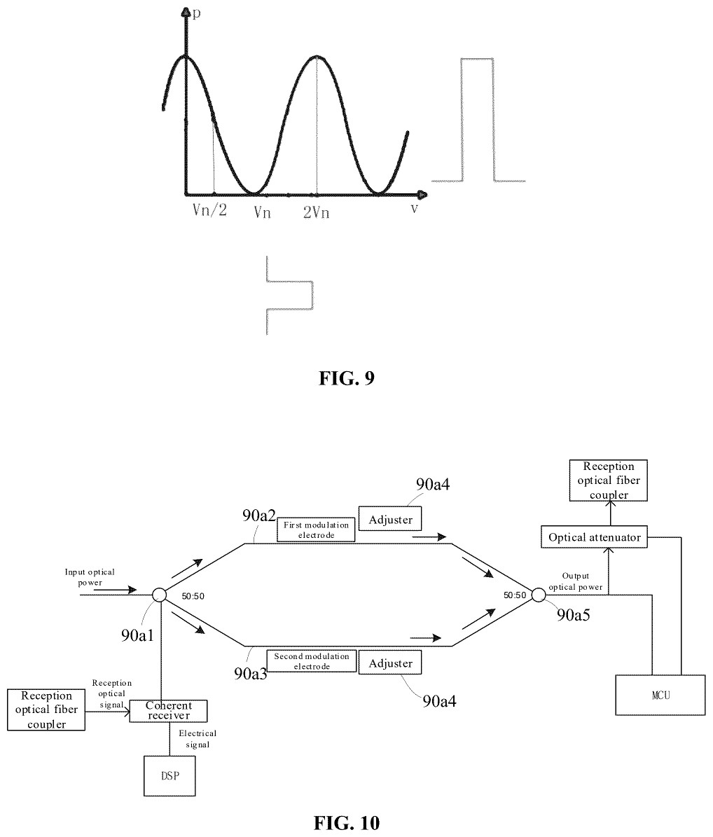

FIG. 10 is a structure block diagram of an optical module provided according to some embodiments of the present disclosure. As shown in FIG. 10, in some examples, the optical modulator of the optical module may include an optical splitter 90a1, a first interference arm 90a2, a second interference arm 90a3, an adjuster 90a4 and a combiner 90a5. In addition, the optical module further includes an optical attenuator, a coherent receiver, a DSP chip, an MCU, a reception optical fiber coupler and an emission optical fiber coupler.

One end of the optical splitter 90a1 is connected to the light source 900b through the optical fiber, and the optical splitter 90a1 is configured to split the emission light that does not carry a signal emitted by the light source 900b, such as direct current light, into two identical beams of light, that is, the optical splitter 90a1 splits the optical signal that does not carry data into a first split light and a second split light.

One end of the first interference arm 90a2 and one end of the second interference arm 90a3 are connected to the optical splitter 90a1, the first interference arm 90a2 is configured to transmit the first split light, and the second interference arm 90a3 is configured to transmit the second split light. That is, the first interference arm 90a2 and the second interference arm 90a3 transmit two optical signals from the optical splitter 90a1 respectively, and the first interference arm 90a2 and the second interference arm 90a3 combine the two optical signals into one optical signal by utilizing the principle of interference of light with the same wavelength.

The first interference arm 90a2 is provided with a first modulation electrode. The first modulation electrode uses electro-optical induction to change the refractive index of the modulator material, converts the modulated electrical signal transmitted by the circuit board 300 into a modulated optical signal, and utilizes the modulated optical signal to convert the direct current optical signal (i.e., the first split light) that does not carry data on the first interference arm 90a2 into a first alternating optical signal with data.

The second interference arm 90a3 is provided with a second modulation electrode. The second modulation electrode uses electro-optical induction to change the refractive index of the modulator material, converts the modulated electrical signal transmitted by the circuit board 300 into a modulated optical signal, and utilizes the modulated optical signal to convert the direct current optical signal (i.e., the second split light) that does not carry data on the second interference arm 90a3 into a second alternating optical signal with data, where the phase of the second alternating optical signal is different from the phase of the first alternating optical signal.

The optical attenuator attenuates the output optical power emitted from the combiner 90a5 after modulation and generates an emission optical signal, and the emission optical signal is transmitted to the emission optical fiber coupler through an emission optical fiber coupling port to achieve the emission of light.

The coherent receiver receives a reception optical signal from the reception optical fiber coupler, and performs balanced detection on the optical signal and the direct current light to generate an electrical signal. The DSP is electrically connected to the coherent receiver and converts this electrical signal into a data signal.

The MCU is connected to the optical attenuator to achieve the switching of power supply to the optical attenuator, and the MCU is further connected to the optical modulator to achieve the switching of a driving circuit of the optical modulator.

The adjuster 90a4 may be arranged on the first interference arm 90a2 and/or the second interference arm 90a3, and the adjuster 90a4 is mainly configured to make the phase difference between the alternating optical signals transmitted on the first interference arm 90a2 and the second interference arm 90a3 constant. The adjuster 90a4 may be a heater arranged on the first interference arm 90a2 and the second interference arm 90a3; it may also be a phase shifter arranged on the first interference arm 90a2 and/or the second interference arm 90a3; it may also be a combination of the heater and the phase shifter arranged on the first interference arm 90a2 and/or the second interference arm 90a3; and certainly, it may also be a phase converter arranged on the first interference arm 90a2 or the second interference arm 90a3.

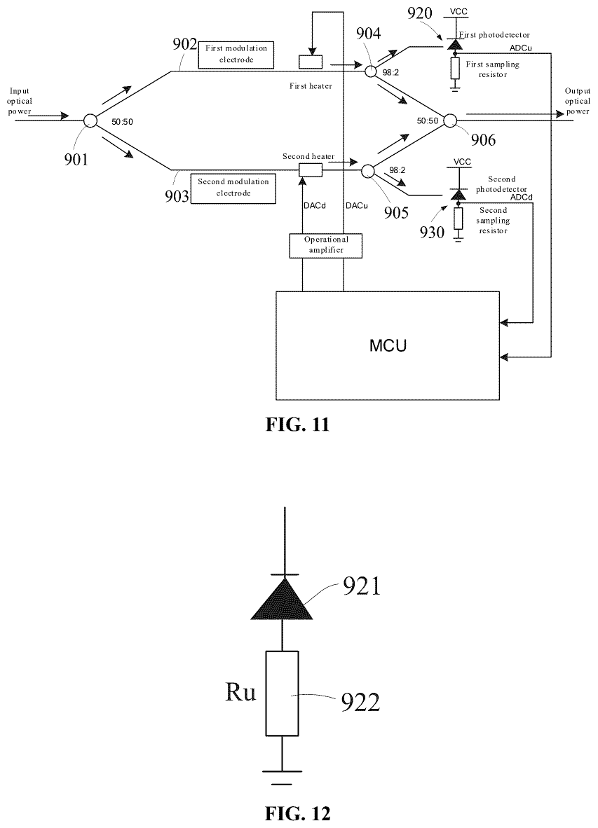

FIG. 11 is a second structural diagram of an electro-optical modulator in an optical module provided according to some embodiments of the present disclosure.

As shown in FIG. 11, in one example, the adjuster may be a heater arranged on the first interference arm 902 and the second interference arm 903, for example, the heater includes a first heater and a second heater, that is, the first interference arm 902 and the second interference arm 903 are heated or cooled by controlling the operation of the first heater and the second heater.

When the heater heats or cools the first interference arm 902 and the second interference arm 903, the refractive index of the first interference arm 902 and the second interference arm 903 can be changed, such that the optical path difference between two alternating optical signals entering the first heater and the second heater is changed, and then the phase difference between the two alternating optical signals passing through the two heaters is changed, thereby keeping the phase difference between the two alternating optical signals passing through the two heaters stable at π/2.

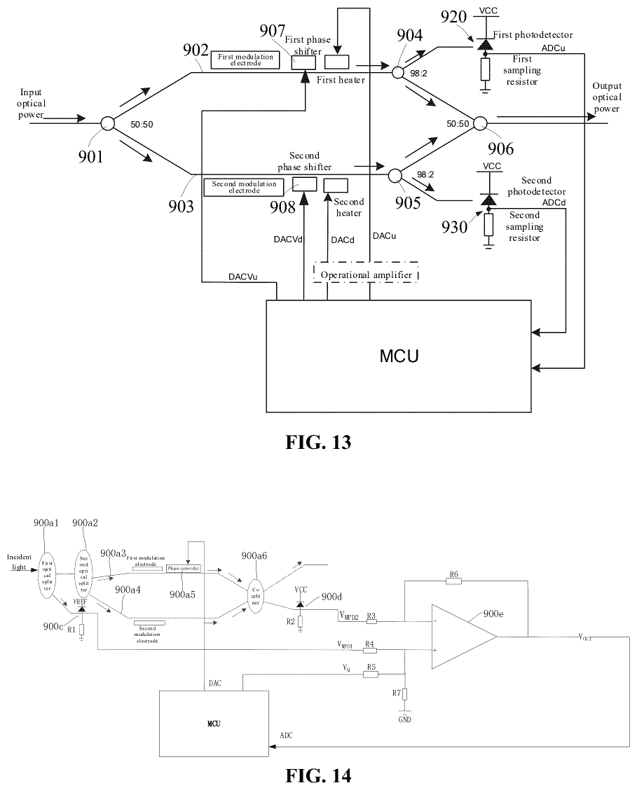

FIG. 13 is a third structural diagram of an electro-optical modulator in an optical module provided according to some embodiments of the present disclosure.

As shown in FIG. 13, in one example, the adjuster may include a phase shifter arranged on at least one interference arm. The phase shifter can change the refractive index of the interference arm, such that the refractive index of the interference arm is jointly controlled by the phase shifter and the heater. The adjusted voltage of the heater is less than the adjusted voltage of the phase shifter, such that the working point of the optical modulator is locked to the optimal working point under the action of a low heating current, thereby reducing the power consumption of the optical module.

Specifically, a first phase shifter 907 and a first heater may be arranged on the first interference arm 902, and only a second heater is arranged on the second interference arm 903; alternatively, only a first heater is arranged on the first interference arm 902, and a second phase shifter 908 and a second heater are arranged on the second interference arm 903; alternatively, a first phase shifter 907 and a first heater are arranged on the first interference arm 902, and a second phase shifter 908 and a second heater are arranged on the second interference arm 903. The refractive index of the first interference arm 902 and the second interference arm 903 can be changed through the above arrangement, such that the optical path difference between the two interference arms can be changed, thereby ensuring that the two interference arms produce a constant phase difference, and locking the working point of the MZM modulator at the optimal working point.

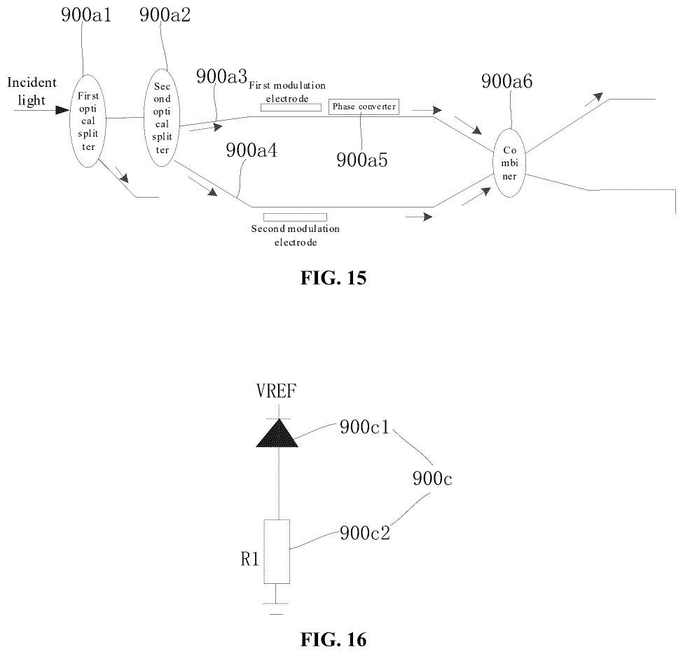

FIG. 14 is an internal structure diagram of another optical module according to some embodiments of the present disclosure, and FIG. 15 is a structural diagram of another optical modulation chip provided according to some embodiments of the present disclosure.

As shown in FIG. 14 and FIG. 15, in one example, the adjuster may include a phase converter 900a5. The phase difference between the light output by the first modulation electrode and the light output by the second modulation electrode is adjusted by the phase converter 900a5 by π/2, such that the working point of the MZM modulator is locked to the optimal working point.

When solving the problem that the optimal working point of the MZM modulator drifts due to a series of external conditions such as time, ambient temperature, emitted optical power of a laser, and insertion and coupling loss of optical fibers, a feedback compensation circuit of a photodetector (PD) can be built to ensure that the two arm electrodes produce a constant phase difference to maintain long-term stability at the optimal working point.

In order to adjust the refractive index of the first interference arm and the second interference arm through the adjuster to ensure that the two arm electrodes produce a constant phase difference to maintain long-term stability at the optimal working point, the optical module in the embodiments of the present application further includes an optical power detection assembly, where the optical power detection assembly is arranged at the side of the optical modulator, and can be specifically arranged on at least light output sides of two interference arms (i.e., an upper arm modulation electrode Mu and a lower arm modulation electrode Md) to obtain a detection voltage. The MCU is electrically connected to the circuit board, and the MCU is configured to produce a constant phase difference between the two arm electrodes and keep it stable at the optimal working point for a long time, such that the detection voltage is adjusted to a preset voltage. The following introduces the method for adjusting the detection voltage to the preset voltage in combination with two examples.

It can be understood that the light output side of the interference arm may be one side directly connected to a light output port of the interference arm, such that the optical power detection assembly can detect at least a voltage of split light emitted by the light output port of the interference arm. In some examples, the light output side of the interference arm may also be one side of a light output side of a combiner (as will be mentioned in the following examples), such that the optical power detection assembly can detect at least a modulated optical voltage of a light output port of the combiner.

In addition, the MCU can send a control signal to the adjuster to control the operation of the adjuster, such that the adjuster can adjust the phases of the two arm electrodes to produce a constant phase difference between the two arm electrodes.

The control signal may be a driving voltage or a driving current. In some examples, the MCU may directly send the driving voltage or the driving current to the adjuster to control the operation of the adjuster. In some other examples, the MCU may also control a power supply to work, such that the power supply sends the driving voltage or the driving current to the adjuster. This is not limited in the embodiments of the present disclosure.

As shown in FIG. 11, in some examples, the adjuster may be a heater arranged on the first interference arm 902 and the second interference arm 903, and the optical modulator includes a first optical splitter 901, a first interference arm 902, a second interference arm 903, and a combiner 906.

The first optical splitter 901 can split an optical signal into two optical signals that are identical, or two optical signals that are not identical. In order to facilitate the interference of two optical signals, the first optical splitter 901 splits an optical signal into two identical optical signals.

For example, the first heater and the second heater are configured to control the phase difference between the alternating optical signals transmitted on the first interference arm 902 and the second interference arm 903 to be constant according to the driving voltage sent by the MCU. That is, the first heater and the second heater are controlled to work according to the driving voltage sent by the MCU to heat or cool the first interference arm 902 and the second interference arm 903.

The following is a method for adjusting the detection voltage to a preset voltage when the adjuster is a heater.

As shown in FIG. 11, in this example, the optical modulator further includes a second optical splitter 904 and a third optical splitter 905, where the second optical splitter 904 is arranged at one end of the first interference arm 902, and the second optical splitter 904 is configured to split the alternating optical signal on the first interference arm 902 into an optical signal with a small proportion and an optical signal with a large proportion. That is, the second optical splitter 904 splits the alternating optical signal on the first interference arm 902 into two alternating optical signals, where the two optical signals are a first alternating optical signal and a second alternating optical signal respectively, the first alternating optical signal is an alternating optical signal with a small proportion, and the second alternating optical signal is an alternating optical signal with a large proportion. In some embodiments, the power ratio of the first alternating optical signal to the second alternating optical signal may be set to 2:98.

Correspondingly, the third optical splitter 905 is arranged at one end of the second interference arm 903, and the third optical splitter 905 is configured to split the alternating optical signal on the second interference arm 903 into an optical signal with a small proportion and an optical signal with a large proportion. That is, the third optical splitter 905 splits the alternating optical signal on the second interference arm 903 into two alternating optical signals, where the two optical signals are a third alternating optical signal and a fourth alternating optical signal respectively, the third alternating optical signal is an alternating optical signal with a small proportion, and the fourth alternating optical signal is an alternating optical signal with a large proportion. In some embodiments, the power ratio of the third alternating optical signal to the fourth alternating optical signal may be set to 2:98.

One end of the combiner 906 is connected to one end of the second optical splitter 904 and one end of the third optical splitter 905 separately, and the combiner 906 is configured to combine two alternating optical signals with a large proportion into one alternating optical signal. That is, the combiner 906 combines the second alternating optical signal and the fourth alternating optical signal with a large proportion into an alternating optical signal, and transmits the alternating optical signal to achieve the transmission of the alternating optical signal.

In some embodiments, the optical modulation chip 900a, such as a thin-film lithium niobate chip, includes an input optical port, an output optical port, a monitoring optical port, a high-speed electrical signal input interface, and a direct current bias signal input interface, where the input optical port is configured to couple the light that does not carry data output by the light source 900b into the optical modulation chip 900a, and the light input through the input optical port is split into two beams of light of a same proportion through the first optical splitter 901.

The output optical port is connected to the combiner 906, and after the combiner 906 combines the second alternating optical signal and the fourth alternating optical signal into an alternating optical signal, the alternating optical signal is transmitted through the output optical port.

In some embodiments, the optical power of the optical modulation chip 900A can be detected through the optical power detection assembly, so as to determine the state of the working point of the optical modulation chip 900A. Therefore, the optical power detection assembly provided in the embodiments of the present disclosure may include a first optical power detection assembly 920, a second optical power detection assembly 930, and an MCU. The first optical power detection assembly 920 and the second optical power detection assembly 930 are separately connected to the optical modulation chip 900a by means of surface mount technology, the first optical power detection assembly 920 is connected to one end of the second optical splitter 904, the first optical power detection assembly 920 is configured to acquire a second alternating optical signal with a small proportion, and the first optical power detection assembly 920 converts the second alternating optical signal into a voltage signal to obtain a corresponding first sampling voltage.

The second optical power detection assembly 930 is connected to one end of the third optical splitter 905, the second optical power detection assembly 930 is configured to acquire a third alternating optical signal with a small proportion, and the second optical power detection assembly 930 converts the third alternating optical signal into a voltage signal to obtain a corresponding second sampling voltage.

The monitoring optical port is connected to the second optical splitter 904 and the third optical splitter 905, the first alternating optical signal split by the second optical splitter 904 is transmitted to the first optical power detection assembly 920 through the monitoring optical port, the third alternating optical signal split by the third optical splitter 905 is transmitted to the second optical power detection assembly 930 through the monitoring optical port, the modulated optical signal is monitored through the first optical power detection assembly 920 and the second optical power detection assembly 930, and a photocurrent is generated by the photodetector, acquired by a sampling circuit and transmitted to the MCU for processing. That is, in this example, the MCU is configured to receive the first sampling voltage and the second sampling voltage where the detection voltage includes the first sampling voltage and the second sampling voltage.

The high-speed electrical signal input interface is connected to the first modulation electrode and the second modulation electrode, and a high-speed electrical signal is input to the first modulation electrode and the second modulation electrode through the high-speed electrical signal input interface to carry out optical modulation on the first interference arm 902 and the second interference arm 903.

The direct current bias signal input interface is connected to the MCU, the first heater, and the second heater, and the MCU inputs a direct current bias voltage (current) signal to the direct current bias signal input interface, and applies the direct current bias voltage (current) signal to the first heater and the second heater to control the optimal working point of the MZM modulator.

Affected by the change of the working temperature of the modulator, the working point of the optical modulation chip 900A is likely to drift, such that the optical modulation chip 900A is not in the state of the optimal working point. In view of this, the working point of the optical modulation chip 900A needs to be locked to the optimal working point. For example, when the detection voltage received by the MCU is not equal to a first preset voltage, the driving voltage output to the heater is adjusted, such that the detection voltage finally reaches the first preset voltage. In this example, the preset voltage is equal to the first preset voltage.

FIG. 12 is a structural diagram of a first optical power detection assembly in an optical module provided according to some embodiments of the present disclosure. As shown in FIG. 12, in some embodiments, the first optical power detection assembly 920 includes a first photodetector 921 and a first sampling resistor 922, where the first photodetector 921 is electrically connected to the first sampling resistor 922 and can be connected by means of wire bonding.

One end of the first photodetector 921 is electrically connected to an external power supply, and the first photodetector 921 is configured to convert an optical signal with a small proportion into a sampling current. One end of the first sampling resistor 922 is electrically connected to the first photodetector 921, the other end of the first sampling resistor 922 is grounded, and the first sampling resistor 922 is configured to convert the sampling current into a sampling voltage, that is, the sampling current undergoes voltage division through the first sampling resistor to obtain a first sampling voltage.

In some embodiments, the second optical power detection assembly 930 includes a second photodetector and a second sampling resistor, where the second photodetector is electrically connected to the second sampling resistor, and can be connected by means of wire bonding.

One end of the second photodetector is electrically connected to the external power supply, and the second photodetector is configured to convert an optical signal with a small proportion into a sampling current. One end of the second sampling resistor is electrically connected to the second photodetector, the other end of the second sampling resistor is grounded, and the second sampling resistor is configured to convert the sampling current into a sampling voltage, that is, the sampling current undergoes voltage division through the second sampling resistor to obtain a second sampling voltage.

The MCU is electrically to the first optical power detection component 920 and the second optical power detection assembly 930 separately, and can be connected by means of surface mount technology. The MCU is configured to perform comparative analysis on the detection voltage, such as a first sampling voltage and a second sampling voltage, and determine, according to a comparative analysis result, whether the output driving voltage should be increased or decreased, to control the voltages applied to the first heater and the second heater through the driving voltage, so as to form different currents. The heater produces a thermal effect due to the injection of current, such that the refractive index of the interference arm is changed, and then the optical path difference between the first interference arm 902 and the second interference arm 903 is changed, thereby ensuring that the first sampling voltage and the second sampling voltage are ultimately equal to the preset voltage, such as a first preset voltage.

In some embodiments, the change of the driving voltage output by the MCU to the heater affects the phase change of the optical signals output by the two interference arms, and the signal amplitude change of the first photodetector 921 and the second photodetector, that is, the first sampling voltage and the second sampling voltage are affected, so as to form a closed feedback control loop. The whole loop will dynamically stabilize the MZM modulator between the slight voltage increases and decreases at the optimal working point, and achieve the automatic compensation for the direct current bias of the MZM modulator at any time.

In some embodiments, the first heater on the first interference arm 902 and the second heater on the second interference arm 903 need to work at 1.5 V, and then adjust the driving voltage output by the MCU to the first heater and the second heater is adjusted according to the change of the optical power received by the first photodetector and the second photodetector, where the driving voltage can be increased or decreased.

In the whole process, it is necessary to ensure that the optical power received by the first photodetector and the optical power received by the second photodetector are equal. If the monitored power of the photodetector decreases, the heating current and the driving voltage are reduced. If the monitored power of the photodetector increases, the heating current and the driving voltage are increased.

In some embodiments, the heater on the interference arm is a heating resistor, and the MCU controls the voltage applied to the heating resistor, thereby forming different currents. The heating resistor produces a thermal effect due to the injection of current, thereby changing the refractive index of the interference arm. However, the refractive index of the interference arm is proportional to the current injected into the heating resistor, such that when the refractive index of the MZM modulator is changed by the heating resistor, additional power consumption is caused.

The following is a method for adjusting the detection voltage to a preset voltage when the adjuster includes a phase shifter in addition to the heater.

As shown in FIG. 13, in order to reduce the additional power consumption caused by the heating resistor, a phase shifter is arranged on at least one interference arm. The MCU sends a driving voltage to the phase shifter, and then the phase shifter can change the refractive index of the interference arm under the action of the driving voltage, such that the refractive index of the interference arm is jointly controlled by the phase shifter and the heater. The adjusted voltage of the heater is less than the adjusted voltage of the phase shifter, until the detection voltage received by the MCU is equal to the preset voltage, such that the working point of the optical modulator is locked at the optimal working point under the action of a low heating current, thereby reducing the power consumption of the optical module.

For example, a first phase shifter 907 and a first heater may be arranged on the first interference arm 902, and only a second heater is arranged on the second interference arm 903. A first sampling voltage of an output optical signal from the first interference arm 902 is acquired through the first optical power detection assembly 920, and a second sampling voltage of an output optical signal from the second interference arm 903 is acquired through the second optical power detection assembly 930. The MCU performs comparative analysis on the first sampling voltage and the second sampling voltage, determines whether the driving voltage should be increased or decreased currently, and performs output by a digital-to-analog converter (DAC) to control the voltages applied to the first phase shifter 907, the first heater, and the second heater. And the adjusted voltages of the first heater and the second heater are less than the adjusted voltage of the first phase shifter 907, such that the refractive index of the first interference arm 902 and the second interference arm 903 is changed, and then the optical path difference between the two interference arms is changed, thereby ensuring that the two interference arms produce a constant phase difference, and locking the working point of the MZM modulator at the optimal working point.

In some embodiments, only a first heater is arranged on the first interference arm 902, and a second phase shifter 908 and a second heater are arranged on the second interference arm 903. A first sampling voltage of an output optical signal from the first interference arm 902 is acquired through the first optical power detection assembly 920, and a second sampling voltage of an output optical signal from the second interference arm 903 is acquired through the second optical power detection assembly 930. The MCU performs comparative analysis on the first sampling voltage and the second sampling voltage, determines whether the driving voltage should be increased or decreased currently, and performs output by a DAC to control the voltages applied to the first heater, the second phase shifter 908, and the second heater. And the adjusted voltages of the first heater and the second heater are less than the adjusted voltage of the second phase shifter 908, such that the refractive index of the first interference arm 902 and the second interference arm 903 is changed, and then the optical path difference between the two interference arms is changed, thereby ensuring that the two interference arms produce a constant phase difference, and locking the working point of the MZM modulator at the optimal working point.

In some embodiments, a first phase shifter 907 and a first heater are arranged on the first interference arm 902, and a second phase shifter 908 and a second heater are arranged on the second interference arm 903. A first sampling voltage of an output optical signal from the first interference arm 902 is acquired through the first optical power detection assembly 920, and a second sampling voltage of an output optical signal from the second interference arm 903 is acquired through the second optical power detection assembly 930. The MCU performs comparative analysis on the first sampling voltage and the second sampling voltage, determines whether the driving voltage should be increased or decreased currently, and performs output by a DAC to control the voltages applied to the first phase shifter 907, the first heater, the second phase shifter 908, and the second heater. And the adjusted voltages of the first heater and the second heater are less than the adjusted voltages of the first phase shifter 907 and the second phase shifter 908, such that the refractive index of the first interference arm 902 and the second interference arm 903 is changed, and then the optical path difference between the two interference arms is changed, thereby ensuring that the two interference arms produce a constant phase difference, and locking the working point of the MZM modulator to the optimal working point.

When a phase shifter is arranged on the interference arm, a phase shifter can be arranged on each of the first interference arm 902 and the second interference arm 903. The driving voltages applied to the two phase shifters are controlled by the MCU. The driving voltage is set within a range from low to high, for example, 0-3 V. The MCU draws a voltage-power response curve for the phase shifters according to the first sampling voltage and the second sampling voltage obtained by the first optical power detection assembly 920 and the second optical power detection assembly 930. One of the phase shifters with the highest efficiency, and the other phase shifter can be discarded.

Because the heaters are arranged on the interference arms, the driving voltages applied to the two heaters are controlled by the MCU. The driving voltage is set from low to high. The MCU draws a voltage-power response curve for the heaters according to the first sampling voltage and the second sampling voltage obtained by the first optical power detection assembly 920 and the second optical power detection assembly 930.

The voltage-power response curve for the phase shifters is combined with the voltage-power response curve for the heaters to obtain voltages of the phase shifters and voltages of the heaters that correspond to the preset power. In order to reduce the current injected into the heater, the driving voltage applied to the phase shifter is adjusted within a large range to coarsely adjust a power curve, then the driving voltage applied to the heater is adjusted within a small range, and a low current is provided to the heater to finely adjust the power curve. Thus, the working point of the MZM modulator is locked to the optimal working point under the joint control of the phase shifter and the heater.

In some embodiments, the MCU can apply 90% of the driving voltage to the phase shifter and 10% of the driving voltage to the heater to reduce the current injected into the heater, thereby reducing the additional power consumption caused by the heating resistor.

In some embodiments, when the MCU analyzes that the first sampling voltage is equal to the second sampling voltage and is not equal to the first preset voltage, the MCU outputs equal driving voltages to the first phase shifter and the second phase shifter, and outputs equal heating voltage signals to the first heater and the second heater, such that the adjusted first sampling voltage and the adjusted second sampling voltage are both equal to the first preset voltage, thereby locking the working point of the MZM modulator to the optimal working point.

When the MCU analyzes that the first sampling voltage is not equal to the second sampling voltage and is not equal to the first preset voltage, the MCU outputs unequal driving voltages to the first phase shifter and the second phase shifter, and outputs unequal heating voltage signals to the first heater and the second heater, such that the adjusted first sampling voltage and the adjusted second sampling voltage are both equal to the first preset voltage, thereby locking the working point of the MZM modulator to the optimal working point.

In some embodiments, a piezoelectric crystal is used as the phase shifter, and the refractive index of the interference arm is changed by integrating a piezoelectric device on the interference arm of the MZM modulator. The piezoelectric crystal is a pressure-sensitive device that can work with only a working voltage and has a small load, such that basically no additional current is generated, and thus no additional power consumption is caused.

The phase shifter provided in the embodiments of the present disclosure is not only limited to the piezoelectric crystal, and any phase shifter that works according to the driving voltage and does not consume additional power falls within the scope of protection of the present disclosure.

In some embodiments, after the MCU obtains the first sampling voltage and the second sampling voltage, a power response curve can also be generated according to the first sampling voltage, the second sampling voltage, the driving voltage output to the phase shifter, and the driving voltage output to the heater; the MCU compares the power response curve with a preset power response curve; and when the power response curve is inconsistent with the preset power response curve, the MCU adjusts the driving voltage output to the phase shifter according to the corresponding driving voltage in the preset power response curve to coarsely adjust the power response curve. Then the MCU adjusts the driving voltage output to the heater according to the corresponding driving voltage in the preset power response curve to ensure that the adjusted voltage output to the heater is less than the adjusted voltage output to the phase shifter, such that the coarsely adjusted power response curve is finely adjusted to make the adjusted power response curve consistent with the preset power response curve, thereby locking the working point of the MZM modulator to the optimal working point.

According to the obtained optical power and the relationship between the driving voltage output to the phase shifter and the driving voltage output to the heater, the MCU can perform curve fitting, and the result is stored in the MCU; and temperature compensation is performed, and the result is saved as a lut table for long-term operation of the optical module. When the working environment of the optical module changes, the MCU automatically reads the lut values for calibration to ensure that the optical module can be stably locked to the optimal working point under different conditions.

According to the optical module provided in the present disclosure, the phase shifters are added to the two interference arms of the optical modulator. The phase difference between the output optical signals from the two interference arms is coarsely adjusted by controlling the driving voltages applied to the phase shifters, and then the phase difference between the output optical signals from the two interference arms is finely adjusted by controlling the driving voltages applied to the heaters, such that the driving voltages applied to the heaters are reduced, thereby reducing the power consumption of the optical module, and improving the quality of the signals transmitted by the optical module.

Certainly, the adjuster may also be a phase converter connected to the MCU in the optical modulator, thereby solving the problem that the optimal working point of the MZM modulator drifts due to a series of external conditions such as time, ambient temperature, and emitted power of a laser.

For example, in this example, the MCU is configured to receive a test voltage corresponding to the detection voltage and adjust a bias voltage provided to the phase converter when the test voltage is not equal to a preset voltage (e.g., a second preset voltage), where the preset voltage corresponds to the second preset voltage, that is, in this example, the preset voltage is equal to the second preset voltage. For example, when the test voltage reaches the preset voltage, the detection voltage output by the modulator reaches the preset voltage, such that the MZM modulator reaches the optimal working point.

The following is a method for adjusting the detection voltage to a preset voltage when the adjuster is a phase converter.

As shown in FIG. 14 and FIG. 15, specifically, in some other embodiments, the optical modulator includes a first optical splitter 900a1, a second optical splitter 900a2, a first interference arm 900a3, a second interference arm 900a4, a phase converter 900a5, and a combiner 900a6.

The first optical splitter 900A1 is configured to split the light that does not carry a signal emitted by the light source into a modulated light and a first monitoring light of different proportions.

The second optical splitter 900a2 is connected to the first optical splitter 900a1 and is configured to split the above modulated light into a first split light and a second split light of a same proportion.

The first interference arm 900a3 is connected to the second optical splitter 900a2, the first interference arm 900a3 is provided with a first modulation electrode, and the first split light is transmitted through the first interference arm 900a3.

The second interference arm 900a4 is connected to the second optical splitter 900a2, the second interference arm 900a4 is provided with a second modulation electrode, and the second split light is transmitted through the second interference arm 900a4.

The first modulation electrode changes the refractive index of the modulator material by using electro-optical induction, converts the modulated electrical signal output by the circuit board 300 into a modulated optical signal, and utilizes the modulated optical signal to convert the direct current optical signal that does not carry data on the first interference arm, that is, the first split light, into a first alternating optical signal with data; the second modulation electrode changes the refractive index of the modulator material by using electro-optical induction, converts the modulated electrical signal output by the circuit board 300 into a modulated optical signal, and utilizes the modulated optical signal to convert the direct current optical signal that does not carry data on the second interference arm, that is, the second split light, into a second alternating optical signal with data; and the phase of the first alternating optical signal and the phase of the second alternating optical signal are different. The other end of the first interference arm is connected to a first input of the combiner 900a6, and the other end of the second interference arm is connected to a second input of the combiner 900a6. The combiner 900a6 couples the first alternating optical signal and the second alternating optical signal into a beam of emission light and a beam of second monitoring light, such that information is loaded into the light to form an optical signal with information, thereby completing the modulation process of the emission light. The emission light is output through the output optical port of the optical modulation chip, such as a thin-film lithium niobate chip, and the second monitoring light is not output through the output optical port of the optical modulation chip, such as a thin-film lithium niobate chip.

When the phase converter 900a5 adjusts the phase difference between the light output by the first modulation electrode and the light output by the second modulation electrode by π/2 under the action of the bias voltage output by the MCU, the optical modulation chip, such as a thin-film lithium niobate chip, is in the state of the optimal working point. Affected by the change of the working temperature of the optical modulator, the working point of the optical modulation chip is prone to drift, such that the optical modulation chip is not in the state of the optimal working point. In view of this, the working point of the optical modulation chip needs to be locked to the optimal working point.

In some embodiments, the optical power is detected through the optical power detection assembly, such as a backlight detector, so as to determine the state of the working point of the optical modulation chip. For example, the backlight detector may be a monitor photodiode (MPD). The MPD is a silicon-based detector, and the MPD can be directly integrated in the silicon photonic chip, for example, the silicon-based detector is grown inside the silicon photonic chip. However, when the optical modulation chip is a thin-film lithium niobate chip with relatively low optical loss, the MPD cannot be integrated inside the thin-film lithium niobate chip because it is silicon-based, and the MPD needs to be arranged outside the thin-film lithium niobate chip. For example, the MPD is mounted on the exterior of the thin-film lithium niobate chip by means of an optical adhesive.

In some embodiments, outside the thin-film lithium niobate chip, a first optical power detection assembly 900C is arranged at a light input side of the optical modulator, for example. The first optical power detection assembly 900C is connected to an optical port from which the first monitoring light is output to detect the optical power of the first monitoring light.

In some embodiments, outside the thin-film lithium niobate chip, a second optical power detection assembly 900d is arranged at a light output side of the optical modulator, for example. The second optical power detection assembly 900d is connected to an optical port through which the second monitoring light is output to monitor the optical power of the second monitoring light.

FIG. 16 is a structural diagram of a first optical power detection assembly in another optical module provided according to some embodiments of the present disclosure. As shown in FIG. 16, in some embodiments, the first optical power detection assembly 900c includes a first optical power detector (such as a first MPD 900c1) and a first resistor 900c2. One end of the first MPD 900c1 is electrically connected to a reference voltage, the other end of the first MPD 900c1 is electrically connected to one end of the first resistor 900c2, and the other end of the first resistor 900c2 is grounded. The first MPD 900c1 has a certain responsivity, converts the detected optical signal into a response current, and converts the response current into a first detection voltage through the first resistor 900c2. Since the first MPD 900c1 is mounted and fixed by means of the optical adhesive, the responsivity of the first MPD 900c1 fluctuates within a certain range due to a certain error in the surface mount position, such that the first detection voltage also fluctuates within a certain range.

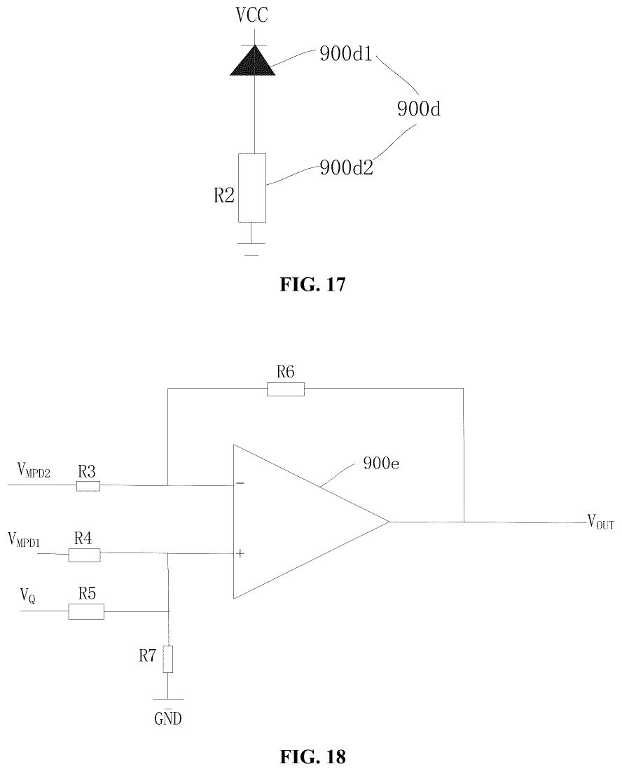

FIG. 17 is a structural diagram of a second optical power detection assembly in another optical module provided according to some embodiments of the present disclosure. As shown in FIG. 17, in some embodiments, the second optical power detection assembly 900d includes a second optical power detector (such as a second MPD 900d1) and a second resistor 900d2. One end of the second MPD 900d1 is electrically connected to a reference voltage, the other end of the second MPD 900d1 is electrically connected to one end of the second resistor 900d2, and the other end of the second resistor 900d2 is grounded. The second MPD 900d1 has a certain responsivity, converts the detected optical signal into a response current, and converts the response current into a second detection voltage through the second resistor 900d2. Since the second MPD 900d1 is mounted and fixed by means of the optical adhesive, the responsivity of the second MPD 900d1 fluctuates within a certain range due to a certain error in the surface mount position, such that the second detection voltage also fluctuates within a certain range.

FIG. 18 is a structural diagram of a comparison circuit in another optical module provided according to some embodiments of the present disclosure. As shown in FIG. 18, in some embodiments, the optical module further includes a comparison circuit 900e. The comparison circuit 900e has a first input, a second input, and an output. The first input is electrically connected to an output of the second optical power detection assembly 900d to receive the second detection voltage. The second input is electrically connected to an output of the first optical power detection assembly 900c to receive the first detection voltage. For example, the comparison circuit 900e is an operational amplifier with a first input being a negative input and a second input being a positive input.

The comparison circuit 900e outputs a comparison voltage according to the first detection voltage and the second detection voltage, and the comparison voltage can be monitored as an output voltage by the MCU. It should be noted that in this example, if the test voltage corresponding to the detection voltage received by the MCU is the comparison voltage, the MCU adjusts the test voltage to the preset voltage, namely the second preset voltage, that is, the MCU adjusts the comparison voltage to the preset voltage, such that the detection voltage is adjusted to the preset voltage.

For example, the comparison voltage is related to the difference between the first detection voltage and the second detection voltage. In some embodiments, when the optical module is in a preset state, for example, the optical modulator of the optical modulation chip 900a, such as a thin-film lithium niobate chip is in the state of the optimal working point, and the comparison voltage is used as the second preset voltage. When it is monitored that the comparison voltage is not equal to the second preset voltage, it means that the optical modulator of the thin-film lithium niobate chip is not in the state of the optimal working point, and the MCU adjusts the bias voltage provided to the phase converter 900a5, such that the refractive index of one of the interference arms is adjusted, the second detection voltage is changed, and the difference between the first detection voltage and the second detection voltage is adjusted to a preset difference, thereby making the comparison voltage reach the second preset voltage, and enabling the optical modulator of the thin-film lithium niobate chip to be in the state of the optimal working point. For example, the preset difference corresponds to the second preset voltage.

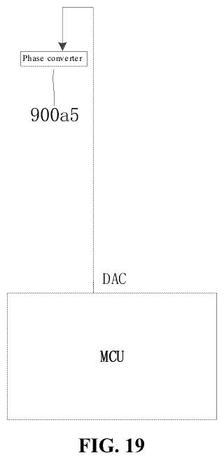

FIG. 19 is a schematic diagram of the interaction between an MCU and a phase converter in another optical module provided according to some embodiments of the present disclosure. As shown in FIG. 19, by adjusting the bias voltage provided to the phase converter 900A5, the difference between the first detection voltage and the second detection voltage is adjusted to a preset difference, such that the comparison voltage is adjusted to the second preset voltage, and the working point of the optical modulator is adjusted to the optimal working point, thereby achieving continuous feedback control.

The comparison voltage can only be monitored by the MCU when it is a non-negative voltage. However, because the first MPD 900c1 and the second MPD 900d1 are external, the surface mount position is random within a certain range, such that the magnitude relationship between the first detection voltage and the second detection voltage cannot be ensured, and the difference between the first detection voltage and the second detection voltage of the optical module may be positive or negative. For different optical modules, the difference between the first detection voltage and the second detection voltage varies. That is, for different optical modules, the difference between the first detection voltage and the second detection voltage is uncertain. For example, for a first optical module, the difference between the first detection voltage and the second detection voltage may be positive; for a second optical module, the difference between the first detection voltage and the second detection voltage may be negative and cannot be detected by the MCU; and for a third optical module, the difference between the first detection voltage and the second detection voltage may also be negative and cannot be detected by the MCU.

In some embodiments, when the difference between the first detection voltage and the second detection voltage is negative and cannot be detected by the MCU, the resistance value of the first resistor or the second resistor is adjusted by replacing the first resistor 900c2 or the second resistor 900d2, such that the difference between the first detection voltage and the second detection voltage is non-negative. However, replacing the resistor will inevitably increase the production cost, and when the production volume is large, there will be many optical modules where the difference between the first detection voltage and the second detection voltage is negative, which will increase the workload and reduce the working efficiency.

In some embodiments, the first resistor 900c2 and the second resistor 900d2 are kept unchanged, and a compensation voltage is provided to the comparison circuit 900e through the MCU. For example, the output of the MCU is electrically connected to the second input of the comparison circuit 900e to output the compensation voltage to the comparison circuit 900e. The compensation voltage can compensate for the voltage deviation caused by the surface mount technology, so as to ensure that the comparison voltage is a non-negative voltage and can be monitored by the MCU. The second input of the comparison circuit 900e receives the first detection voltage and the compensation voltage simultaneously, such that an input voltage of a positive input of the comparison circuit 900e is increased to be greater than an input voltage of a negative input, thereby ensuring that the comparison voltage output by the comparison circuit 900e is a non-negative voltage.

In some embodiments, when the optical module is in a preset state, if the comparison voltage cannot be monitored, a first compensation voltage is input to the comparison circuit 900e, and the second input of the comparison circuit 900e receives the first detection voltage and the first compensation voltage simultaneously, such that an input voltage of a positive input of the comparison circuit 900e is increased to be greater than an input voltage of a negative input, thereby ensuring that the comparison voltage output by the comparison circuit 900e is a non-negative voltage.

In some embodiments, when the optical module is in a preset state, if the comparison voltage is monitored, a second compensation voltage is input to the comparison circuit 900e. For example, the second compensation voltage is 0 V. In other words, if the comparison voltage is monitored when the optical module is in the preset state, the compensation voltage is not input to the comparison circuit 900e.

For example, when the optical module is in the preset state, if the MCU monitors that the comparison voltage is 0 V, it either means that the comparison voltage is not monitored, or that the comparison voltage output by the comparison circuit 900e is 0 V. In order to facilitate control, when the optical module is in the preset state, when the MCU monitors that the comparison voltage is 0 V, the compensation voltage is uniformly input to the comparison circuit 900e, and the compensation voltage is gradually increased until the comparison voltage output by the comparison circuit 900e reaches the second preset voltage.

In some embodiments, the bias voltage provided to the phase converter 900a5 is adjusted to ensure that the difference between the first detection voltage and the second detection voltage is non-negative, but when the bias voltage provided to the phase converter 900a5 is adjusted indefinitely, although the difference can be ensured to be non-negative, it is possible that the working point of the optical modulator in the optical modulation chip is no longer the optimal working point.

For different optical modules, the second preset voltage corresponding to the comparison circuit 900e may be the same fixed value or a different fixed value, for example, the second preset voltage corresponding to the comparison circuit 900e is the same fixed value and recorded as Vₚᵣₑₛₑₜ. For any optical module, when the optical module is in the preset state, if the MCU monitors that the comparison voltage is 0 V, the compensation voltage is input to the comparison circuit 900e, and the compensation voltage is gradually increased until the comparison voltage output by the comparison circuit 900e reaches the second preset voltage Vₚᵣₑₛₑₜ.

For different optical modules, the compensation voltage input by the MCU to the comparison circuit 900e may vary. For example, the second preset voltage of the first optical module is Vₚᵣₑₛₑₜ, and the compensation voltage is V_{Q1}; the second preset voltage of the second optical module is Vₚᵣₑₛₑₜ, and the compensation voltage is V_{Q2}; the second preset voltage of the third optical module is Vₒᵤₜ, and the compensation voltage is V_{Q3}; and the second preset voltage of the fourth optical module is Vₚᵣₑₛₑₜ, and the compensation voltage is V_{Q4}.

In some embodiments of the present disclosure, under the premise of keeping the hardware structure unchanged, a compensation voltage is provided to the comparison circuit through the MCU, so as to avoid replacing the resistor. The comparison voltage is monitored by the MCU from a software perspective, and the compensation voltage participates in the locking of the working point. This can reduce production costs and improve production efficiency.

For an optical module, when it is in the preset state, if the MCU monitors that the comparison voltage is 0 V, the compensation voltage is input to the comparison circuit 900e, and the compensation voltage is gradually increased until the comparison voltage output by the comparison circuit 900e reaches the second preset voltage Vₚᵣₑₛₑₜ. In this case, the compensation voltage is V_{Q}. In order to facilitate the locking of the working point, the compensation voltage V_{Q} will maintain a continuous and constant output. When the drift occurs at the working point, under the effect of the compensation voltage V_{Q}, the MCU adjusts the bias voltage provided to the phase converter 900a5 to ensure that the difference between the first detection voltage and the second detection voltage reaches the preset difference, such that the comparison voltage reaches the second preset voltage Vₚᵣₑₛₑₜ, and the corresponding working point is the optimal working point.

In some embodiments, a third resistor R3 is arranged between the output of the second optical power detection assembly 900d and the first input of the comparison circuit 900e, and the third resistor R3 is a current limiting resistor. The third resistor R3 reduces the power consumption control voltage on the one hand, and plays a role in safety protection on the other hand.

In some embodiments, a fourth resistor R4 is arranged between the output of the first optical power detection assembly 900c and the second input of the comparison circuit 900e, and the fourth resistor R4 is a current limiting resistor and is connected in parallel with the third resistor R3. On the one hand, the fourth resistor R4 reduces the power consumption control voltage, and on the other hand, it plays a role in safety protection.

In some embodiments, a fifth resistor R5 is arranged between the output of the MCU and the second input of the comparison circuit 900e, and the fifth resistor R5 is a current limiting resistor. The fifth resistor R5, the fourth resistor R4, and the third resistor R3 are connected in parallel. The fifth resistor R5 reduces the power consumption control voltage on the one hand, and plays a role in safety protection on the other hand.

In some embodiments, a sixth resistor R6 is arranged between the first input of the comparison circuit 900e and the output of the comparison circuit 900e. The sixth resistor R6 is connected in parallel with the third resistor R3 and plays a role in amplifying the output voltage.

In some embodiments, a seventh resistor R7 is connected in parallel with the fifth resistor R5, where one end of the seventh resistor R7 is electrically connected to the second input of the comparison circuit 900e, and the other end of the seventh resistor R7 is grounded.

In some embodiments, the comparison circuit 900e outputs a comparison voltage according to the first detection voltage, the second detection voltage, and the compensation voltage.

For example, according to the first resistor, the second resistor, the third resistor R3, the fourth resistor R4, the fifth resistor R5, and the sixth resistor R6, Vₒᵤₜ=[(R_{P}*R₃+R₆*R_{P})/(R₃*R₄)]*V_{MPD1}+[(R₃*R_{P}+R₆*R_{P})/(R₃*R₅)]*V_{Q}−R₆/R₃*V_{MPD2},
where Vₒᵤₜ is the output voltage of the comparison circuit 900e; R_{P}−R₄/R₅/R₇; V_{MPD1} is the first detection voltage, and V_{MPD1} is numerically equal to the response current detected by the first MPD multiplied by the first resistance; V_{MPD2} is the second detection voltage, and V_{MPD2} is numerically equal to the response current detected by the second MPD multiplied by the second resistance; and V_{Q} is the compensation voltage input by the MCU to the comparison circuit 900e.

When the resistances are adjusted to satisfy: R₃/R₆=R₄/R₅/R₇, and R₃=R₄=R₅=R, Vₒᵤₜ=R₆(V_{MPD1}/R+V_{Q}/R−V_{MPD2}/R). It can be seen that the comparison voltage Vₒᵤₜ output by the comparison circuit 900e is related to the first detection voltage V_{MPD1}, the second detection voltage V_{MPD2}, and the compensation voltage V_{Q}. The fixed compensation voltage V_{Q} is kept output. If the difference between the first detection voltage V_{MPD1} and the second detection voltage V_{MPD2} is adjusted to the preset difference, the comparison voltage Vₒᵤₜ can reach the second preset voltage Vₚᵣₑₛₑₜ to adjust the working point of the optical modulator in the optical modulation chip to the optimal working point. For example, the fixed compensation voltage V_{Q} is kept output, and when the difference between the first detection voltage V_{MPD1} and the second detection voltage V_{MPD2} is the preset difference, the comparison voltage Vₒᵤₜ can reach the second preset voltage, and the corresponding working state of the optical modulation chip is the optimal working point.

In some embodiments, the output of the constant compensation voltage is maintained, and when the comparison voltage Vₒᵤₜ output by the comparison circuit 900e is not the second preset voltage, it indicates that the corresponding working state of the optical modulator in the optical modulation chip is not the optimal working point, and the difference between the first detection voltage V_{MPD1} and the second detection voltage V_{MPD2} is adjusted to a preset difference by adjusting the bias voltage provided to the phase converter 900a5, such that the comparison voltage is adjusted to the second preset voltage, and the working point of the optical modulator is adjusted to the optimal working point.

In some embodiments, the second preset voltage corresponding to the comparison voltage corresponding to each optical module is uniformly denoted as Vₚᵣₑₛₑₜ.

In some embodiments, at room temperature, the bias voltage provided to the phase converter 900a5 is adjusted to ensure that the output optical power is half of the maximum optical power, such that the optical modulation chip works at the optimal working point. If the comparison voltage output by the comparison circuit 900e is monitored to be 0 V, the compensation voltage is gradually input to the comparison circuit 900e, and the compensation voltage is gradually increased until the comparison voltage output by the comparison circuit 900e reaches the second preset voltage Vₚᵣₑₛₑₜ; and the compensation voltage V_{Q} at this time is recorded. The compensation voltage V_{Q} is then kept continuously and constantly output. Since the working state of the optical modulation chip is the optical working point at this time, the compensation voltage V_{Q} is correspondingly output to ensure that the comparison voltage Vₒᵤₜ reaches the second preset voltage Vₚᵣₑₛₑₜ, such that the compensation voltage V_{Q} should be continuously and constantly output to ensure that when the comparison voltage Vₒᵤₜ reaches the second preset voltage Vₚᵣₑₛₑₜ. the working state of the optical modulation chip is the optimal working point at this time. At a high or low temperature, the fixed compensation voltage V_{Q} is kept output, and when the comparison voltage Vₒᵤₜ output by the comparison circuit 900e is not the second preset voltage Vₚᵣₑₛₑₜ, it indicates that the corresponding working state of the optical modulation chip is not the optimal working point, and the bias voltage provided to the phase converter 900a5 is adjusted to adjust the difference between the first detection voltage V_{MPD1} and the second detection voltage V_{MPD2} to a preset difference, such that the comparison voltage is adjusted to the second preset voltage Vₚᵣₑₛₑₜ, and the working point of the optical modulator is adjusted to the optimal working point.

In some embodiments of the present application, for the same optical module, the compensation voltage V_{Q} is continuously and constantly output in all temperature zones, and then when the comparison voltage output by the comparison circuit 900e is not the second preset voltage, it indicates that the corresponding working state of the optical modulation chip is not the optimal working point, and the bias voltage provided to the phase converter 900a5 is adjusted to adjust the difference between the first detection voltage V_{MPD1} and the second detection voltage V_{MPD2} to a preset difference, such that the comparison voltage is adjusted to the second preset voltage Vₚᵣₑₛₑₜ, and the working point of the optical modulator is adjusted to the optimal working point, thereby achieving continuous feedback control. For example, for the same optical module, the compensation voltage V_{Q} is a fixed value in different temperature zones.

In some embodiments of the present application, for different optical modules, the compensation voltage V_{Q} varies, and the second preset voltage Vₚᵣₑₛₑₜ remains the same.

In the present application, due to the nature of the thin-film lithium niobate chip, the first MPD 900c1 and the second MPD 900d1 are externally placed on the thin-film lithium niobate chip, and the surface mount position is random within a certain range, such that the magnitude relationship between the first detection voltage and the second detection voltage cannot be ensured, and the difference between the first detection voltage and the second detection voltage of the optical module may be positive or negative. On the premise of keeping the hardware structure unchanged, the compensation voltage is provided to the comparison circuit through the MCU, and the comparison voltage is monitored by the MCU from a software perspective, so as to save production costs and improve production efficiency.

In the present application, for the same optical module, the continuous and constant output of the compensation voltage is maintained in different temperature zones, and the difference between the first detection voltage V_{MPD1} and the second detection voltage V_{MPD2} is adjusted to a preset difference by adjusting the bias voltage provided to the phase converter, such that the comparison voltage is adjusted to the second preset voltage, and the working point of the optical modulator is adjusted to the optimal working point, thereby achieving continuous feedback control.

When the optical module works normally, the emitted optical power needs to be turned on and off. For example, in a coherent optical module, the light emitted by the laser is not only used to output the emission optical signal after modulation, but also used to undergo balanced detection with the reception optical signal. Turning off the laser will affect the optical signal at the reception end.

In order to solve the above problem, the embodiments of the present disclosure further provide an optical module and a method for turning on and off the emitted optical power of the optical module.

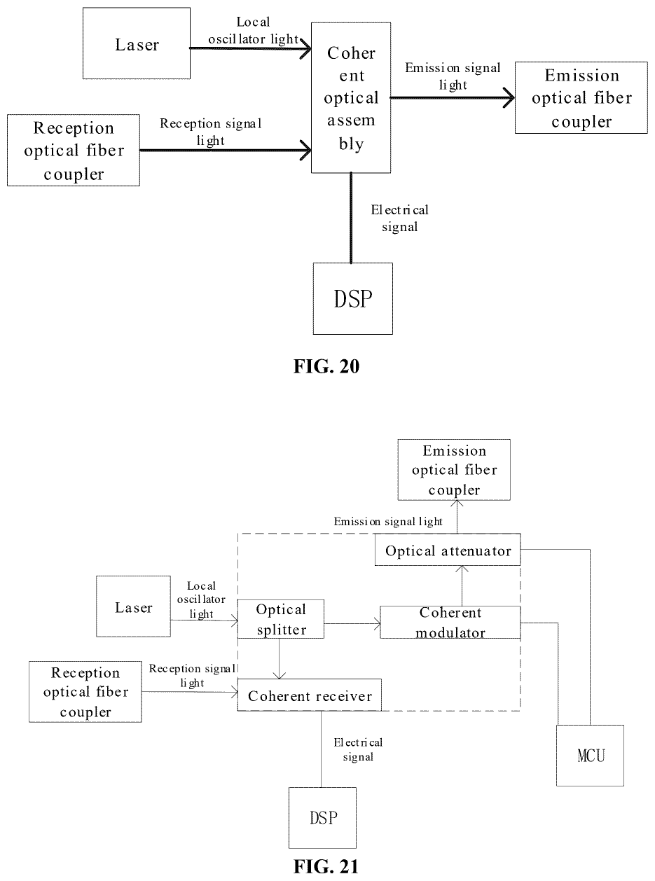

FIG. 20 is a first block diagram of a structure on a circuit board in another optical module provided according to some embodiments of the present disclosure. As shown in FIG. 20, a coherent optical assembly includes a coherent optical chip and an electrical chip. The coherent optical chip, the electrical chip, and a circuit board are packaged to achieve signal transmission among the circuit board, the electrical chip, and the coherent optical chip. The coherent optical chip has a local oscillator fiber coupling port, a reception optical fiber coupling port, and an emission optical fiber coupling port. The local oscillator fiber coupling port corresponds to the local oscillator optical assembly 401, such that the light generated by the light source enters the coherent optical chip through the local oscillator fiber coupling port, the light is modulated inside the coherent optical chip to generate an optical signal, the optical signal is transmitted to the emission optical fiber coupler through the emission optical fiber coupling port, the emission optical fiber coupler couples the optical signal output from the coherent optical chip to the emission optical fiber, and then the optical signal is coupled to the optical fiber adapter through the emission optical fiber, thereby achieving the emission of light.

The optical fiber adapter is connected to the reception optical fiber coupler through the internal optical fiber, and the reception optical fiber coupler is connected to an optical fiber inlet, such that the external optical signal transmitted by the optical fiber adapter enters the coherent optical chip through the reception optical fiber, the reception optical fiber coupler, and the reception optical fiber coupling port, the coherent optical chip converts the optical signal into an electrical signal, and then the electrical signal after passing through an amplifying device is transmitted to the circuit board, and is transmitted to the host computer through the gold finger on the circuit board 300, thereby achieving the reception of light.

In order to achieve the control of the laser and the coherent optical assembly, an MCU is further provided to control the laser, the coherent optical assembly, and the DSP chip.

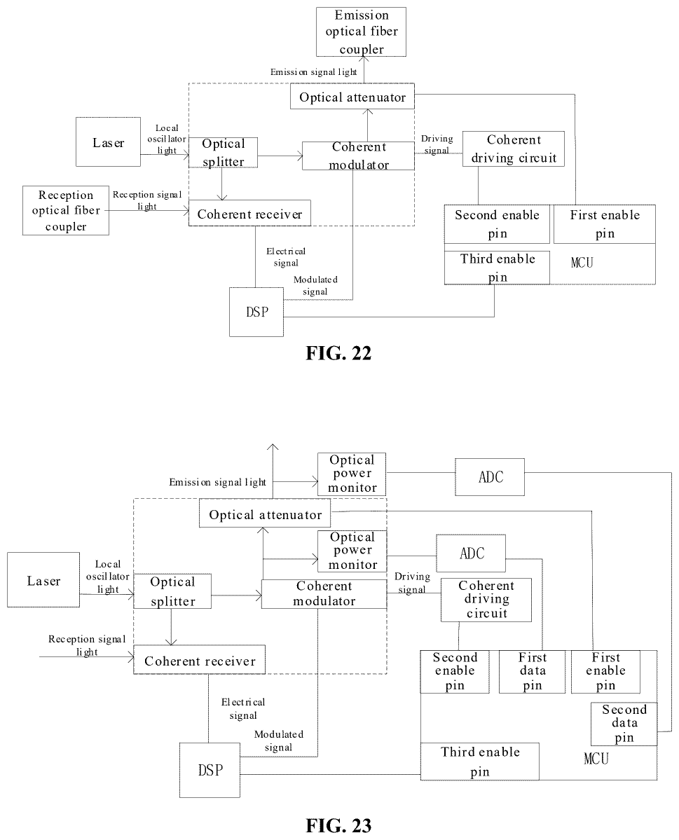

FIG. 21 is a second block diagram of a structure on a circuit board in another optical module provided according to the embodiments of the present disclosure. FIG. 22 is a third block diagram of a structure on a circuit board in another optical module provided according to the embodiments of the present disclosure. As shown in FIG. 21 and FIG. 22, the coherent optical assembly further includes: an optical splitter, a coherent receiver, an optical modulator (also known as a coherent modulator), and an optical attenuator. The optical splitter splits local oscillator light emitted by the laser into two beams. One beam enters the coherent modulator, and the coherent modulator modulates the light to generate a modulated optical signal. The modulated optical signal is attenuated by the optical attenuator to generate an emission optical signal. The other beam of the local oscillator light enters the coherent receiver, and the coherent receiver also receives a reception optical signal from the reception optical fiber coupler, and performs balanced detection on the reception optical signal and the local oscillator light to generate an electrical signal. The DSP is electrically connected to the coherent receiver and converts this electrical signal into a data signal.

The circuit board is further provided with an MCU, and the MCU includes a plurality of enable pins, where a first enable pin is connected to the optical attenuator and is configured to achieving the switching of power supply to the optical attenuator; a second enable pin is connected to the coherent modulator and is configured to achieve the switching of a driving circuit of the coherent modulator; the coherent driving circuit is connected to the coherent modulator and is configured to achieve power supply to the coherent modulator and provide a driving signal for the coherent modulator; and a third enable pin is connected to the DSP chip and is configured to control the switching of a modulated signal from the coherent modulator by the DSP chip.

In the coherent optical module, it is necessary to ensure that the reception port works normally when the emitted optical power is turned off, and at the same time meet the timing requirements of turning on and off the emitted optical power. Generally, the timing requirements of turning on and off the emitted optical power are as follows: the time for the emitted optical power to decrease to less than −30 dBm is less than 100 ms, and the time for the emitted optical power to return to more than −10 dBm is less than 10 ms.

In order to solve the above problems, in the optical module provided in the present disclosure, when the MCU receives an instruction of deactivating emission of optical power, the third enable pin outputs a first enable signal, the DSP chip is controlled not to send the modulated signal to the coherent modulator, and the first enable pin outputs a first control signal to the optical attenuator, such that the attenuation value of the optical attenuator is maximized, and the optical power of the attenuated emission optical signal is less than −30 dBm. When the MCU receives an instruction of activating emission of optical power, the third enable pin outputs a second enable signal, the DSP chip is controlled to send the modulated signal to the coherent modulator, and the first enable pin outputs a second control signal to the optical attenuator, such that the attenuation value of the optical attenuator is minimized. In this process, the MCU controls a driving signal from the coherent driving circuit, such that the driving voltage of the coherent modulator is always at the optimal working point.

In the embodiments of the present application, when the MCU controls the driving signal from the coherent driving circuit to ensure that the driving voltage of the coherent modulator is always at the optimal working point, the optical power of the modulated optical signal is about −20 dBm according to the working principle of the coherent modulator. After the MCU receives the instruction of deactivating emission of optical power, the MCU parses the instruction of deactivating emission of optical power, the third enable pin outputs the first enable signal, the DSP chip is controlled not to send the modulated signal to the coherent modulator, and the first enable pin outputs the first control signal to the optical attenuator, such that the attenuation value of the optical attenuator is maximized. When the maximum attenuation value of the optical attenuator in the present application is 10 dBm, the optical power of the attenuated emission optical signal is less than −30 dBm.

When the MCU receives the instruction of activating emission of optical power, the instruction of activating emission of optical power is parsed, the third enable pin outputs the second enable signal, the DSP chip is controlled to send the modulated signal to the coherent modulator, and the first enable pin outputs the second control signal to the optical attenuator, such that the attenuation value of the optical attenuator is minimized. In the present application, the output of the modulated signal from the DSP and the attenuation value of the optical attenuator can be controlled through the MCU to achieve the turn-on and turn-off of the emitted optical power, and the whole control process is executed by the internal algorithm of the MCU in less than 10 ms, which meets the system requirements.

The optical splitter splits local oscillator light emitted by the laser into two beams. One beam enters the coherent modulator, the coherent modulator modulates the light to generate a modulated optical signal, and the modulated optical signal is attenuated by the optical attenuator to generate an emission optical signal. The other beam of the local oscillator light enters the coherent receiver, the coherent receiver also receives a reception optical signal from the reception optical fiber coupler, and performs balanced detection on the reception optical signal and the local oscillator light to generate an electrical signal. The DSP is electrically connected to the coherent receiver and converts the electrical signal into a data signal.

The DSP is connected to the coherent modulator and sends a modulated signal to the coherent modulator, which receives the modulated signal to modulate the local oscillator and generates a modulated optical signal. The modulated optical signal is then attenuated by an optical attenuator to generate an emission optical signal.

When the MCU receives the instruction of deactivating emission of optical power, the third enable pin outputs the first enable signal, the DSP chip is controlled not to send the modulated signal to the coherent modulator, and the first enable pin outputs the first control signal to the optical attenuator, such that the attenuation value of the optical attenuator is maximized, and the optical power of the attenuated emission optical signal is less than −30 dBm. When the MCU receives the instruction of activating emission of optical power, the third enable pin outputs the second enable signal, the DSP chip is controlled to send the modulated signal to the coherent modulator, and the first enable pin outputs the second control signal to the optical attenuator, such that the attenuation value of the optical attenuator is minimized.

In order to achieve the real-time modulation of the working voltage of the coherent modulator, as shown in FIG. 23 that is a fourth block diagram of a structure on a circuit board in another optical module provided according to the embodiments of the present disclosure, the coherent optical assembly provided in the present application further includes: a modulated optical power monitor and an emitted optical power monitor. The modulated optical power monitor is arranged between the coherent modulator and the optical attenuator and is configured to monitor the optical power of the modulated optical signal transmitted by the coherent modulator. The emitted optical power monitor is arranged at a light output port of the optical attenuator and is configured to monitor the optical power of the emission optical signal attenuated by the optical attenuator. The MCU is provided with a first data pin and a second data pin, which are connected to the modulated optical power monitor and the emitted optical power monitor, respectively, and receive the optical power of the modulated optical signal and the optical power of the emission optical signal.

The MCU controls the voltage output by the second enable pin to the coherent driving circuit according to the optical power of the received modulated optical signal to control the output voltage from the coherent driving circuit to the coherent modulator, such that the working voltage of the coherent modulator is always at the optimal working point.

The MCU receives the optical power of the emission optical signal and controls the magnitude of the second control signal output by the first enable pin according to the optical power value of the emission optical signal to control the optical attenuation value of the optical attenuator, such that the optical power of the emission optical signal meets the communication requirements.

Specifically, a first analog-to-digital converter is arranged between the first data pin and the modulated optical power monitor, the modulated optical power monitor converts the optical power of the modulated optical signal into an electrical signal, and the analog-to-digital converter is configured to convert the electrical signal into a data signal and send the data signal to the MCU. The MCU stores the data signal and adjusts the output voltage of the second enable pin according to the data signal to control the output voltage of the coherent driving circuit, such that the working point of the coherent modulator is the optimal working point.

A second analog-to-digital converter is arranged between the second data pin and the emitted optical power monitor, the modulated optical power monitor converts the optical power of the emission optical signal into an electrical signal, and the second analog-to-digital converter is configured to convert the electrical signal into a data signal and send the data signal to the MCU. The MCU stores the data signal and adjusts the output voltage of the first enable pin according to the data signal to control the attenuation value of the optical attenuator, so as to control the optical power of the emission optical signal.

In the embodiments of the present application, when the MCU controls the driving signal from the coherent driving circuit to ensure that the driving voltage of the coherent modulator is always at the optimal working point, the optical power of the modulated optical signal is about −20 dBm according to the working principle of the coherent modulator. After the MCU receives the instruction of deactivating emission of optical power, the MCU parses the instruction of deactivating emission of optical power, the third enable pin outputs the first enable signal, the DSP chip is controlled not to send the modulated signal to the coherent modulator, and the first enable pin outputs the first control signal to the optical attenuator, such that the attenuation value of the optical attenuator is maximized. When the maximum attenuation value of the optical attenuator in the present application is 10 dBm, the optical power of the attenuated emission optical signal is less than −30 dBm, thereby achieving the purpose of turning off the emitted optical power.

The present application further provides a method for the optical module to turn on and off the emitted optical power, which is applicable to the MCU of the coherent optical module. The method includes: receiving the instruction of activating emission of optical power, parsing the instruction of activating emission of optical power, controlling the DSP chip not to output the modulated signal to the coherent optical modulator, and controlling the optical attenuation value of the optical attenuator to be maximum; and receiving the instruction of deactivating emission of optical power, parsing the instruction of deactivating emission of optical power, controlling the DSP chip to output the modulated signal to the coherent optical modulator, and controlling the optical attenuation value of the optical attenuator to be minimum attenuation value.

In the embodiments of the present application, the optical module is a coherent optical module, including a local oscillator light source, an optical splitter, a coherent receiver, a coherent modulator, and an optical attenuator. The optical splitter splits local oscillator light emitted by the laser into two beams. One beam enters the coherent modulator, the coherent modulator modulates the light to generate a modulated optical signal, and the modulated optical signal is attenuated by the optical attenuator to generate an emission optical signal. The other beam of the local oscillator light enters the coherent receiver, and the coherent receiver also receives a reception optical signal from the reception optical fiber coupler and performs balanced detection on the reception optical signal and the local oscillator light to generate an electrical signal. The DSP is electrically connected to the coherent receiver and converts the electrical signal into a data signal. The circuit board is further provided with an MCU. The MCU includes a plurality of enable pins, where a first enable pin is connected to the optical attenuator and is configured to achieve the switching of power supply to the optical attenuator; a second enable pin is connected to the coherent modulator and is configured to achieve the switching of a driving circuit of the coherent modulator; the coherent driving circuit is connected to the coherent modulator and is configured to achieve power supply to the coherent modulator and provide a driving signal for the coherent modulator; and a third enable pin is connected to the DSP chip and is configured to control the switching of a modulated signal from the coherent modulator by the DSP chip.

When the MCU receives the instruction of deactivating emission of optical power, the third enable pin outputs the first enable signal, the DSP chip is controlled not to send the modulated signal to the coherent modulator, and the first enable pin outputs the first control signal to the optical attenuator, such that the attenuation value of the optical attenuator is maximized, and the optical power of the attenuated emission optical signal is less than −30 dBm. When the MCU receives the instruction of activating emission of optical power, the third enable pin outputs the second enable signal, the DSP chip is controlled to send the modulated signal to the coherent modulator, and the first enable pin outputs the second control signal to the optical attenuator, such that the attenuation value of the optical attenuator is minimized. In this process, the MCU controls the driving signal from the coherent driving circuit to ensure that the driving voltage of the coherent modulator is always at the optimal working point.

In the embodiments of the present application, when the MCU controls the driving signal from the coherent driving circuit to ensure that the driving voltage of the coherent modulator is always at the optimal working point, the optical power of the modulated optical signal is about −20 dBm according to the working principle of the coherent modulator. After the MCU receives the instruction of deactivating emission of optical power, the MCU parses the instruction of deactivating emission of optical power, the third enable pin outputs the first enable signal, the DSP chip is controlled not to send the modulated signal to the coherent modulator, and the first enable pin outputs the first control signal to the optical attenuator, such that the attenuation value of the optical attenuator is maximized. When the maximum attenuation value of the optical attenuator in the present application is 10 dBm, the optical power of the attenuated emission optical signal is less than −30 dBm.

When the MCU receives the instruction of activating emission of optical power, the instruction of activating emission of optical power is parsed, the third enable pin outputs the second enable signal, the DSP chip is controlled to send the modulated signal to the coherent modulator, and the first enable pin outputs the second control signal to the optical attenuator, such that the attenuation value of the optical attenuator is minimized. In the present application, the output of the modulated signal from the DSP and the attenuation value of the optical attenuator can be controlled through the MCU to achieve the turn-on and turn-off of the emitted optical power, and the whole control process is executed by the internal algorithm of the MCU in less than 10 ms, which meets the system requirements.

The optical splitter splits local oscillator light emitted by the laser into two beams. One beam enters the coherent modulator, the coherent modulator modulates the light to generate a modulated optical signal, and the modulated optical signal is attenuated by the optical attenuator to generate an emission optical signal. The other beam of the local oscillator light enters the coherent receiver, and the coherent receiver also receives a reception optical signal from the reception optical fiber coupler and performs balanced detection on the reception optical signal and the local oscillator light to generate an electrical signal. The DSP is electrically connected to the coherent receiver and converts the electrical signal into a data signal.

The modulated optical power monitor is arranged between the coherent modulator and the optical attenuator, and is configured to monitor the optical power of the modulated optical signal transmitted by the coherent modulator. The emitted optical power monitor is arranged at the light output port of the optical attenuator and is configured to monitor the optical power of the emission optical signal attenuated by the optical attenuator. The MCU is provided with a first data pin and a second data pin, which are connected to the modulated optical power monitor and the emitted optical power monitor, respectively, and receive the optical power of the modulated optical signal and the optical power of the emission optical signal.

The MCU controls the voltage output by the second enable pin to the coherent driving circuit according to the optical power of the received modulated optical signal to control the output voltage from the coherent driving circuit to the coherent modulator, such that the working voltage of the coherent modulator is always at the optimal working point.

The MCU receives the optical power of the emission optical signal, and controls the magnitude of the second control signal output by the first enable pin according to the optical power of the emission optical signal to control the optical attenuation value of the optical attenuator, such that the optical power of the emission optical signal meets the communication requirements.

Specifically, a first analog-to-digital converter is arranged between the first data pin and the modulated optical power monitor, the modulated optical power monitor converts the optical power of the modulated optical signal into an electrical signal, and the analog-to-digital converter is configured to convert the electrical signal into a data signal and send the data signal to the MCU. The MCU stores the data signal and adjusts the output voltage of the second enable pin according to the data signal to control the output voltage of the coherent driving circuit, such that the working point of the coherent modulator is the optimal working point.

A second analog-to-digital converter is arranged between the second data pin and the emitted optical power monitor, the modulated optical power monitor converts the optical power of the emission optical signal into an electrical signal, and the second analog-to-digital converter is configured to convert the electrical signal into a data signal and send the data signal to the MCU. The MCU stores the data signal, and adjusts the output voltage of the first enable pin according to the data signal to control the attenuation value of the optical attenuator, so as to control the optical power of the emission optical signal.

The foregoing descriptions are only specific embodiments of the present disclosure, but the scope of protection of the present disclosure is not limited to this, and any changes or substitutions conceived by those skilled in the art within the technical scope of the present disclosure shall be covered within the scope of protection of this disclosure. Therefore, the scope of protection of this disclosure shall be subject to the scope of protection of the claims.

What is claimed is:

1. An optical module, comprising:
a light source configured to emit direct current light that does not carry data;
an optical modulation chip which comprises an optical modulator, the optical modulator being configured to modulate the direct current light that does not carrying data into an optical signal, and the optical modulator comprising a phase converter;
a first optical power detection assembly arranged at a light input side of the optical modulator, a detection voltage of the first optical power detection assembly being a first detection voltage;
a second optical power detection assembly arranged at a light output side of the optical modulator, a detection voltage of the second optical power detection assembly being a second detection voltage, and wherein the optical module is in a preset state when a difference between the first detection voltage and the second detection voltage is a preset difference;
a comparison circuit, wherein a first input of the comparison circuit receives the second detection voltage, and a second input of the comparison circuit receives the first detection voltage; the comparison circuit is configured to output a comparison voltage according to the first detection voltage and the second detection voltage, and the optical module is in the preset state when the comparison voltage is a preset voltage; and
an MCU configured to monitor the comparison voltage output by the comparison circuit, and is in signal connection with the phase converter to output a bias voltage to the phase converter; and the MCU is configured to adjust the bias voltage that is provided to the phase converter in case of monitoring that the comparison voltage is not equal to the preset voltage while the optical module is in the preset state, such that the difference between the first detection voltage and the second detection voltage is the preset difference, thereby adjusting the comparison voltage to the preset voltage.

2. The optical module according to claim 1, wherein
the comparison voltage cannot be monitored if it is a negative voltage;
the second input of the comparison circuit is also configured to receive a compensation voltage output by the MCU; and the comparison circuit is configured to output a comparison voltage according to the first detection voltage, the second detection voltage and the compensation voltage; and
the MCU is configured to provide the compensation voltage to the comparison circuit when the optical module is in the preset state such that the comparison voltage is a non-negative voltage, keep outputting the compensation voltage, and adjust the bias voltage provided to the phase converter when it is monitored that the comparison voltage is not equal to the preset voltage.

3. The optical module according to claim 2, wherein the MCU is configured to provide the compensation voltage to the comparison circuit such that the comparison voltage is a non-negative voltage, when the optical module is in the preset state while no comparison voltage is monitored.

4. The optical module according to claim 2, wherein the MCU is configured to provide the compensation voltage to the comparison circuit when the optical module is in the preset state and the comparison voltage is monitored.

5. The optical module according to claim 1, wherein the optical modulation chip further comprises:
a first optical splitter configured to split the direct current light that does not carry data emitted by the light source into a modulated light and a first monitoring light of different proportions, wherein an optical port from which the first monitoring light is output is connected to the first optical power detection assembly;
a second optical splitter which is connected to the first optical splitter and is configured to split the modulated light into a first split light and a second split light of a same proportion;
a first interference arm which is connected to the second optical splitter and configured to transmit the first split light;
a second interference arm which is connected to the second optical splitter and configured to transmit the second split light; and
a combiner which is configured to combine the first split light and the second split light and couple them into an emission light and a second monitoring light, wherein an optical port through which the second monitoring light is output is connected to the second optical power detection assembly.

6. The optical module according to claim 1, wherein the first optical power detection assembly comprises a first optical power detector and a first resistor, and wherein one end of the first optical power detector is electrically connected to a reference voltage, the other end of the first optical power detector is electrically connected to one end of the first resistor, and the other end of the first resistor is grounded; and
the second optical power detection assembly comprises a second optical power detector and a second resistor, and wherein one end of the second optical power detector is electrically connected to a reference voltage, the other end of the second optical power detector is electrically connected to one end of the second resistor, and the other end of the second resistor is grounded.

7. The optical module according to claim 1, wherein a third resistor is arranged between an output of the second optical power detection assembly and the first input of the comparison circuit, and the third resistor is a current limiting resistor.

8. The optical module according to claim 7, wherein a fourth resistor is arranged between an output of the first optical power detection assembly and the second input of the comparison circuit, and the fourth resistor is a current limiting resistor and is connected in parallel with the third resistor.

9. The optical module according to claim 8, wherein a fifth resistor is arranged between an output of the MCU and the second input of the comparison circuit, and wherein the fifth resistor is a current limiting resistor; and the fifth resistor, the fourth resistor and the third resistor are respectively connected in parallel.

10. The optical module according to claim 7, wherein a sixth resistor is arranged between the first input of the comparison circuit and an output of the comparison circuit, and the sixth resistor is connected in parallel with the third resistor.

11. The optical module according to claim 9, wherein a seventh resistor is arranged in parallel with the fifth resistor, one end of the seventh resistor being electrically connected to the second input of the comparison circuit, and the other end of the seventh resistor being grounded.

12. The optical module according to claim 1, wherein the optical modulator is at an optimal working point when the optical module is in the preset state.

13. The optical module according to claim 1, wherein the optical module further comprises:
an optical attenuator which is connected to an output of the optical modulator to attenuate a modulated optical signal to generate an emission optical signal;
a DSP chip which is connected to the optical modulator and is configured to output a modulated signal to the optical modulator, wherein
the MCU is connected to the DSP chip and also to the optical attenuator, and is configured to receive an instruction of deactivating emission of optical power, output a first control signal to the optical attenuator, and output a first enable signal to the DSP chip, and wherein the first control signal controls an attenuation value of the optical attenuator to be maximum, and the first enable signal controls the DSP chip not to output a modulated signal to the optical modulator;
the MCU receives an instruction of activating emission of optical power, outputs a second control signal to the optical attenuator, and outputs an enable signal to the DSP chip at the same time, wherein the enable signal controls the DSP to output a modulated signal to the optical modulator, and the second control signal controls an attenuation value of the attenuator to be minimum attenuation value.

14. The optical module according to claim 13, wherein the optical module further comprises:
a modulated optical signal power monitor which is arranged between the optical modulator and the optical attenuator and configured to monitor optical power of a modulated optical signal; and
a coherent driving circuit which is connected to the optical modulator and configured to supply power to the optical modulator;
wherein the MCU is connected to the modulated optical signal power monitor and the coherent driving circuit, and adjusts a voltage to the coherent driving circuit according to optical power of the modulated optical signal to control an output voltage of the coherent driving circuit.

15. The optical module according to claim 14, wherein the MCU is provided with:
a first enable pin which is connected to the optical attenuator;
a second enable pin which is connected to the coherent driving circuit; and
a third enable pin which is connected to the DSP.

16. The optical module according to claim 14, wherein the optical module further comprises an emission optical signal power monitor arranged at an output of the optical attenuator, the emission optical signal power monitor being configured to monitor an optical power of the emission optical signal; and
the MCU is connected to the modulated optical signal power monitor and the coherent driving circuit, and adjusts a voltage to the coherent driving circuit according to an optical power of the modulated optical signal to control an output voltage of the coherent driving circuit.

17. The optical module according to claim 14, wherein the optical module further comprises a first analog-to-digital converter arranged between the modulated optical signal power monitor and the MCU.

18. The optical module according to claim 16, wherein the optical module further comprises a second analog-to-digital converter arranged between the emission optical signal power monitor and the MCU.

19. The optical module according to claim 13, wherein the optical module further comprises:
a reception optical fiber adapter which is connected to an external optical fiber and configured to receive a reception optical signal; and
a coherent receiver which is connected to the light source and the reception optical fiber adapter, the coherent receiver being configured to receive the reception optical signal and light emitted by the light source, and perform balanced detection to convert an optical signal into an electrical signal.

20. The optical module according to claim 19, wherein the DSP is connected to the coherent receiver, and is configured to convert the electrical signal from the coherent receiver into a data signal.
